(19) United States
(12) Patent Application Publication
(10) Pub. No.: US 2025/0320335 A1
(43) Pub. Date: Oct. 16, 2025

(54) POLYOLEFIN MIMIC POLYESTER POLYMERS

(71) Applicant: SABIC Global Technologies B.V., Bergen Op Zoom (NL)

(72) Inventors: Sivadinarayana CHINTA, Bangalore (IN); Alexander STANISLAUS, Bangalore (IN); Girish KORIPELLY, Bangalore (IN); Robbert DUCHATEAU, Bangalore (IN); Kaiwalya SABNIS, Bangalore (IN); Pankaj Singh GAUTAM, Bangalore (IN); Ganesh KANNAN, Bangalore (IN); Ravichander NARAYANASWAMY, Bangalore (IN); Lidia JASINSKA-WALC, Bangalore (IN)

(21) Appl. No.: 18/554,457

(22) PCT Filed: Apr. 8, 2022
(86) PCT No.: PCT/EP2022/059384

§ 371 Date: Oct. 6, 2023

(30) Foreign Application Priority Data
Apr. 8, 2021 (EP) 21167508.7

(51) Int. Cl. C08G 81/02; C08J 11/14; C08J 11/24

(52) U.S. Cl. CPC C08G 81/027; C08J 11/14; C08J 11/24; C08J 2353/00

(57) ABSTRACT

A polymer, methods of making the polymer, methods of recycling the polymer and compositions including the polymer are described. The polymer can contain repeating units of Formula (I), where X is an aliphatic group, and Z is an aliphatic group comprising at least 45 carbon atoms, preferably 45 to 1.000 carbon atoms, and has a degree of saturation of 98 to 100%, wherein the polymer comprises 0.01 to 40 ester groups per 1000 backbone carbon units, and wherein the polymer has a melt temperature (Tₘ) of 40° C. to 180° C.

### BACKGROUND OF THE INVENTION

### A. Field of the Invention

The invention generally relates to chemically recyclable polymers.

### B. Description of Related Art

Polyolefins have multiple industrial uses. Polyolefins such as polyethylene and polypropylene constitute the largest volume of synthetic plastic produced worldwide. Polyolefins are used in wide variety of materials, such as films, sheets, foams, fibers, toys, bottles, containers, furniture, electronic parts, and plumbing materials.

An issue with polyolefins is their poor chemical recyclability back to their respective building blocks or monomeric units. For example, the chemical recycling efficiency back to polyolefin building blocks starting from waste plastic is about 40-50%. One reason for this is the chemical recycling process can produce by-products like aromatics, methane, coke, etc. This means full recycling circularity may not be possible to achieve in the current recycling processes with the polymers currently in use.

### SUMMARY OF THE INVENTION

A discovery has been made that provides a solution to at least some of the problems that may be associated with the chemical recyclability of polymers such as polyolefins. In one aspect, the discovery can include providing polyester polymers that have polyolefin like properties (e.g., crystallinity, melt temperature (Tₘ), etc.), that can readily be recycled to their building blocks. This can increase the chemical recycling efficiency when compared with current polyolefin polymers. In one aspect, it was found that polyester polymers, containing less than 40, such as 0.01 to 40 ester groups, per 1,000 backbone carbon atoms, having relatively high degree of saturation, and/or having relatively low degree of branching, can have polyolefin like properties. As, illustrated, in a non-limiting manner in the examples, a polyester polymer according to one example of the present invention can have a melt temperature and crystallinity similar to a polyolefin, and can readily be recycled to the monomers forming the polymer.

One aspect of the present invention is directed to a polymer. The polymer can contain repeating units of Formula I:

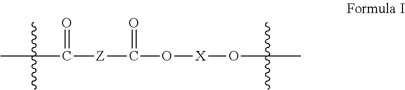

Z can be an aliphatic group. In some aspects, Z can contain at least 45 carbon atoms, and can have a degree of saturation of 97 to 100%, such as 98 to 100%. In some aspects, Z can contain 45 to 1,000 carbon atoms, such as 50 to 800 carbon atoms, such as 60 to 600 carbon atoms. In some aspects, Z can have a degree of branching (DB) of 0 to 10%, such as 0 to 9%, such as 0 to 7%. In certain aspects, Z can vary randomly between the repeating units of Formula I. In certain aspects, the number of carbon atoms and/or DB of the Z group, can vary randomly between the repeating units of Formula I. In certain aspects, i) average number of carbon atoms in the Z groups of the polymer can be 45 to 1000, such as 50 to 800, such as 60 to 600, ii) the Z groups of the polymer can have a polydispersity index of be 1.5 to 4, preferably 1.5 to 3, more preferably 1.5 to 2.5, and/or iii) the average DB of the Z groups of the polymer can be 0 to 10 mol. %, such as 0 to 9 mol. %, such as 0 to 7 mol. %. In certain aspects, Z does not vary between the repeating units of Formula I.

In some aspects, Z can be a linear hydrocarbon. In some aspects, Z can be a branched hydrocarbon having a DB of 0.01 to 10%, such as 0.01 to 9%, such as 0.01 to 7%. In some aspects, a Z having at least 45 carbon atoms, and a degree of branching of 0 to 10%, can provide for an ester/backbone carbon atom ratio suitable for obtaining polyolefin like properties. In some aspects, Z can be a polyolefin group. A polyolefin group can be a polyolefin with one H missing at each of the two ends of the polyolefin backbone chain, where the valency of the terminal carbons are satisfied by bonding with the “—COO—” groups at the two sides of Z. In some aspects, Z can be a linear polyolefin group. In some aspects, Z can be a branched polyolefin group, having a DB of 0.01 to 10%, such as 0.01 to 9%, such as 0.01 to 7%. In some aspects, Z can contain C₁ to C₁₀ hydrocarbon branches. In some aspects, the polyolefin group can be a polyethylene, poly(ethylene-propylene), or poly(ethylene-co-α-olefin), such as poly(ethylene-co-1-butene), poly(ethylene-co-1-hexene), or poly(ethylene-co-1-octene) group. In some aspects, Z can be a linear polyethylene group. In some aspects, Z can be a branched polyethylene group containing C₁ to C₁₀ alkyl group branches, and a DB of 0.01 to 10%, such as 0.01 to 9%, such as 0.01 to 7%.

In some aspects, Z can be a poly(α-olefin) group or a poly(α-olefin-co-ethylene) group having a DB greater than 10%, such as 10% to 50%, wherein the α-olefin monomers of the poly(α-olefin) group or poly(α-olefin-co-ethylene) group contain 3 or more carbons. In some aspects, the poly(α-olefin) group can be a polypropylene group, or a polybutylene group, or a poly(propylene-co-ethylene) group. In some aspects, Z can be an atactic, isotactic, or syndiotactic polypropylene group. In some aspects, Z can be random poly(propylene-co-ethylene) group. In certain aspects, Z can be poly(propylene-co-ethylene) group containing 0.7 to 6.6 mol. % of ethylene.

X can be an aliphatic group. X can contain up to 1000 carbon atoms. In some aspects, X can be a linear hydrocarbon. In some aspects, X can be a branched hydrocarbon. In some aspects, X can be a polyolefin group. A polyolefin group of X can be a polyolefin with one H missing at each of the two ends of the polyolefin backbone chain, where the valency of the terminal carbons are satisfied by bonding with the “—O—” groups at the two sides of X. In some aspects, X can be a linear polyolefin group. In some aspects, X can be a branched polyolefin group having a DB of 0.01 to 50%. In some aspects, X can contain C₁ to C₁₀ hydrocarbon branches. In some aspects, X can be a polyethylene, poly(ethylene-propylene), poly(α-olefin), poly(α-olefin-co-ethylene), or poly(ethylene-co-α-olefin) group. In certain aspects, X can be a poly(ethylene-co-1-butene), poly(ethylene-co-1-hexene), or poly(ethylene-co-1-octene) group. In some aspects, X can be a polypropylene group, or a polybutylene group, or a poly(propylene-co-ethylene) group. In some aspects, X can be an atactic, isotactic, or syndiotactic polypropylene group. In some aspects, X can be random poly(propylene-co-ethylene) group. In certain aspects, X can vary randomly between the repeating units of Formula I. In certain aspects, i) number of carbon atoms in the X groups can vary randomly between the repeating units of Formula I or iii) the DB of the X groups can vary randomly between the repeating units of Formula I. In certain aspects, X does not vary between the repeating units of Formula I.

In certain aspects, X can contain 45 to 1000 carbon atoms. In certain aspects, X can be a C₁ to C₄₄ aliphatic group. In some particular aspects, X can be a C₁ to C₂₀ aliphatic group. In some aspects, X can be a linear or branched, and substituted or unsubstituted hydrocarbon. In some aspects, X can have the formula of (1), (2), (3), (4), or (5):

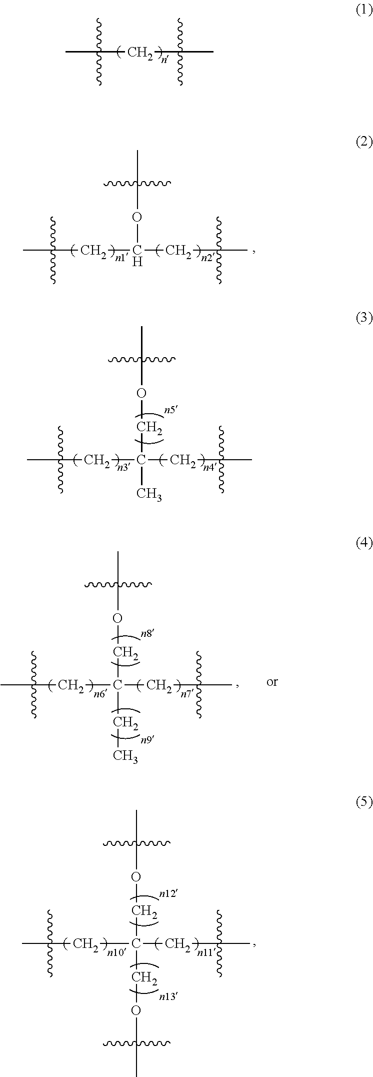

or any combination thereof
wherein n′ in formula (1) is an integer from 1 to 1000 and denotes number of repeat units. In certain aspects, n′ can be an integer from 1 to 15. n1′, n2′, n3′, n4′, n5′, n6′, n7′, n8′, n9′, n10′, n11′, n12′, and n13′, are independently an integer from 1 to 10, and denote number of repeat units. In some aspects, n1′, n2′, n3′, n4′, n5′, n6′, n7′, n8′, n9′, n10′, n11′, n12′, and n13′, are independently an integer from 1 to 5. In certain aspects, the polymer can contain i) repeating units of a first unit having the formula of Formula I, and ii) repeating units of a second unit having the formula of Formula I, wherein X of the first unit can have a different formula than the X of the second unit. In certain aspects, X of the first unit can be a linear hydrocarbon, and the X of the second unit can contain one or more side functional groups. In some aspects, the functional group can be a hydroxyl, acid, amine, or halogen group. The second unit can introduce branching in the polymer. The second unit can be bonded to three or more monomers. In some aspects, X of the first unit has the chemical formula of Formula (1), and X of the second unit has the chemical formula of Formula (2), (3), (4) or (5). The Z of the first unit and the second unit can be same or different, e. g. can have same or different chemical formula. In some aspects, Z of the first unit and the second unit can have the same formula. In some aspects, the polymer can contain the first units and the second units arranged in blocks, randomly or in alternate. In some aspects, the first units and the second units can be arranged randomly in the polymer. In certain aspects, the ratio of mol. % of the first unit and second unit in the polymer can be 9:1 to 999:1, or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 200:1, 300:1, 400:1, 500:1, 600:1, 700:1, 800:1, 900:1, and 999:1.

The polymer of the present invention can have a melt temperature (Tₘ) of 40° C. or over. In some aspects, the polymer can have a melt temperature (Tₘ) of 40° C. to 170° C., such as 85° C. to 165° C., such as 90° C. to 160° C., such as 95° C. to 150° C., such as 110° C. to 145° C. In some aspects, the number average molecular weight (Mn) of the polymer can be 1,0000 to 1,000,000 g/mol, preferably of 20,000 to 500,000 g/mol, more preferably of 40,000 to 200,000 g/mol. The Mn can be determined as the polyethylene equivalent molecular weight by high temperature size exclusion chromatography performed at 160° C. in trichlorobenzene using polyethylene standards. In some aspects, the polymer can have a polydispersity index (PDI), of 1.5 to 4, preferably 1.8 to 3.

The polymer of the present invention may contain 0.01 to 40 ester groups per 1000 backbone carbon units, preferably 0.1 to 30 ester groups per 1000 backbone carbon units, more preferably 1 to 25 ester groups per 1000 backbone carbon units, or any value in between 0.01 and 40.

A preferred aspect is directed to a polymer comprising repeating units of Formula I:

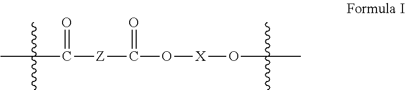

wherein X is an aliphatic group and Z is an aliphatic group comprising at least 45 carbon atoms, preferably 45 to 1,000 carbon atoms, and has a degree of saturation of 98 to 100%, wherein the polymer comprises 0.01 to 40 ester groups per 1000 backbone carbon units, and wherein the polymer has a melt temperature (Tₘ) of 40° C. to 180° C.

In certain aspects, the polymer can contain repeating units of Formula II:

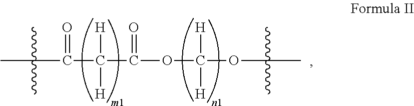

wherein n1 is an integer from 0 to 15 and denotes number of repeat units, where m1 is an integer from 100 to 700 and denotes the number of repeat units. In some aspects, m1 can be an integer from 200 to 600. In some aspects, m1 can be an integer from 100 to 500. In some aspects, m1 can be an integer from 200 to 500. In some aspects, m1 can be an integer from 300 to 500. In certain aspects, m1 can vary randomly between the repeating units of Formula II, and/or the average of m1s in the polymer can be 100 to 700, such as 200 to 600, such as 300 to 500. In certain aspects, m1 does not vary between the repeating units of Formula II.

In some aspects, the polymer can contain repeating units of Formula III:

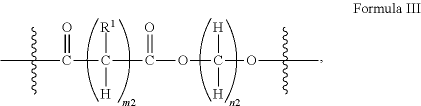

wherein, n2 is an integer from 0 to 15 and denotes number of repeat units, where m2 is an integer from 100 to 700 and denotes the number of repeat units. In some aspects, m2 can be an integer from 200 to 600. In some aspects, m2 can be an integer from 300 to 600. In some aspects, m2 can be an integer from 100 to 520. In some aspects, m2 can be an integer from 400 to 520. R¹ can be —H or a C₁ to C₁₀ alkyl group, and varies independently between —H and the C₁ to C₁₀ alkyl group in the repeating units —CHR¹—, wherein DB of —(CHR¹)ₘ₂— group is 0.01 to 10%, e.g. 0.01 to 10% of R¹ is the C₁ to C₁₀ alkyl group, with the rest being —H. In some aspects, n2 can be 2. In some aspects, R¹ can be —H or —CH₂CH₃. In some aspects, the DB of —(CHR¹)ₘ₂— group can be 0.1 to 5%. In certain aspects, m2 can vary randomly between the repeating units of Formula III, and/or the average of m2s in the polymer can be 200 to 600, such as 300 to 600, such as 400 to 520. In certain aspects, m2 does not vary between the repeating units of Formula III. In certain aspects, DB of the (CHR¹)ₘ₂— group can vary randomly between the repeating units of Formula III, and/or the average DB of the —(CHR¹)ₘ₂— groups of the polymer can be 0.01 to 10%. In certain aspects, DB of the —(CHR¹)ₘ₂— group between the repeating units of Formula III does not vary.

In some aspects, the polymer can have Formula IV, and can contain the blocks A and B:

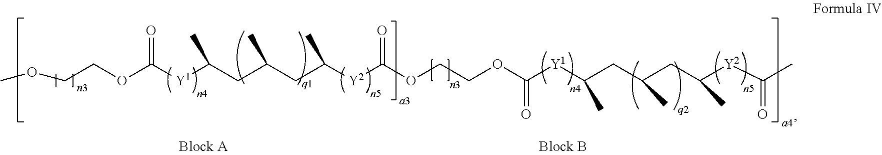

wherein n3 can be an integer from 0 to 14 and denotes number of repeat units, q1 and q2 can independently be integers from 25 to 200, preferably 50 to 125 and denotes number of repeat units, and a3 and a4 are independently an integer. Y¹ and Y² are independently a C₁-C₁₀ hydrocarbons and Y¹ and Y² can be the same or different. n4 and n5 are integer, and can be independently 0 or 1. In some aspects, Y¹ and Y² can independently be —(CH₂)_{n″}—, or —(CH₂)_{n1″}—CH═CH—(CH₂)_{n2″}—. n″ can be an integer from 1 to 10. n1″ and n2″ can independently be and integer from 0 to 4. The length of the blocks can be same or different, e.g., a3 and a4 can be same or different. In certain aspects, q1 can vary randomly in the repeating units forming the Block A, and/or in the Block A average of q1s can be 25 to 200, preferably 50 to 125. In certain aspects, q2 can vary randomly in the repeating units forming the Block B, and/or in the Block B average of q2s can be 25 to 200, preferably 50 to 125. In certain aspects, q1 does not vary in the repeating units forming the Block A, and/or, q2 does not vary in the repeating units forming the Block B.

Certain aspects are directed to a method for forming a polymer described herein. The method can include reacting an α,ω-dicarboxylic acid (diacid) compound having a formula of HO₂C—Z—CO₂H, or the ester thereof with a α,ω-dihydroxy compound having a formula of Formula V. Z can have a structure as described above. The structure of Formula V can be:

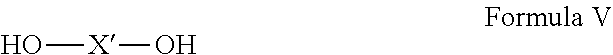

X′ can be an aliphatic group. X′ can contain up to 1000 carbon atoms. In some aspects, X can be a linear hydrocarbon. In some aspects, X′ can be a branched hydrocarbon. In some aspects, X′ can be a polyolefin group. A polyolefin group of X′ can be a polyolefin with one H missing at each of the two ends of the polyolefin backbone chain, where the valency of the terminal carbons are satisfied by bonding with the “—OH” groups at the two sides of X′. In some aspects, X′ can be a linear polyolefin group. In some aspects, X′ can be a branched polyolefin group having a DB of 0.01 to 50%. In some aspects, X′ can contain C₁ to C₁₀ hydrocarbon branches. In some aspects, X′ can be a polyethylene, poly(ethylene-propylene), poly(α-olefin), poly(α-olefin-co-ethylene), or poly(ethylene-co-α-olefin) group. In certain aspects, X can be a poly(ethylene-co-1-butene), poly(ethylene-co-1-hexene), or poly(ethylene-co-1-octene) group. In some aspects, X can be a polypropylene group, or a polybutylene group, or a poly(propylene-co-ethylene) group. In some aspects, X′ can be an atactic, isotactic, or syndiotactic polypropylene group. In some aspects, X′ can be random poly(propylene-co-ethylene) group. In certain aspects, X′ can contain 45 to 1000 carbon atoms. In certain aspects, X′ can be a C₁ to C₄₄ aliphatic group. In some particular aspects, X′ can be a C₁ to C₂₀ aliphatic group. In some aspects, X′ can be a linear or branched, and substituted or unsubstituted hydrocarbon. In some aspects, X′ can have the formula of (1), (6), (7), (8), or (9):

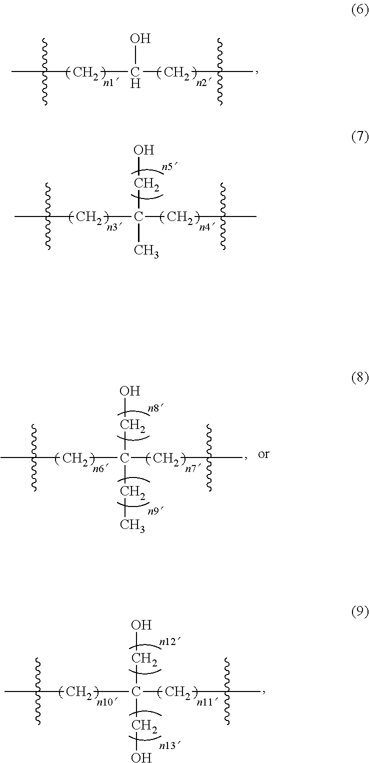

n1′, n2′, n3′, n4′, n5′, n6′, n7′, n8′, n9′, n10′, n1l′, n12′, and n13′, are independently an integer from 1 to 5, and denote number of repeat units. Formula (1) is defined above.

In some aspects, the α,ω-dihydroxy compound (e.g., of Formula V) can be ethylene glycol, 1,3-propanediol, 1,4-butanediol, 1,6-hexanediol, 1,2-cyclohexanediol, 2-butene-1,4-diol, glycerol, trimethalolmethane, trimethalolethane, trimethalolpropane, 3-hydroxymethyl-1,5-pentanediol, pentaerythritol, or any combinations thereof.

In some aspects, HO₂C—Z—CO₂H and/or ester thereof can be reacted with HO—X′—OH (e.g., of Formula V) at i) a temperature of 90 to 250° C., and/or ii) under inert atmosphere and/or vacuum.

Certain aspects are directed to a method for recycling a polymer described herein. The recycling method can include contacting the polymer with water and/or an alcohol under conditions suitable to depolymerize the polymer to produce i) a α,ω-dihydroxy compound having a formula of HO—X—OH, and ii) a diacid having a formula of HO₂C—Z—CO₂H, and/or an ester thereof. The polymer can get depolymerized through hydrolysis (e.g., with water) and/or alcoholysis (e.g., with alcohol). In certain aspects, the polymer can be depolymerized by contacting the polymer with methanol to form an α,ω-dihydroxy compound (e.g., HO—X—OH) and a methyl ester of an acid having a formula of HO₂C—Z—CO₂H. In certain aspects, the depolymerization conditions can include a temperature of 100° C. to 250° C. and/or a pressure of 10 barg to 60 barg.

Certain aspects are directed to a first polymer containing repeating units of Formula I, wherein the first polymer is obtained from the polymerization of an α,ω-dihydroxy compound HO—X—OH with an recycled acid HO₂C—Z—CO₂H and/or ester thereof. The recycled HO₂C—Z—CO₂H (and/or ester thereof), can be obtained from depolymerization of a second polymer containing repeating units of Formula I. The first polymer and the second polymer can be chemically the same or different. In certain aspects, recycled HO₂C—Z—CO₂H (and/or ester thereof), can be polymerized with a recycled α,ω-dihydroxy compound, HO—X—OH.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment discussed herein can be implemented with respect to any method or composition of the invention, and vice versa. Furthermore, compositions of the invention can be used to achieve methods of the invention.

The following includes definitions of various terms and phrases used throughout this specification.

The term “degree of branching (DB)” of a group/oligomer/polymer refers to % of branched carbons in the backbone of the group/oligomer/polymer. For example, the following group having the formula of Formula (16), has a degree of branching 25%. The branched carbons in the backbone of the group of Formula 16 is marked with a *. R′ in formula 16 is a branching group, can be an alkyl group, and r is an integer and denotes number of repeat units.

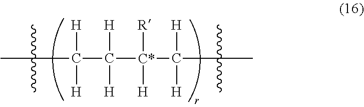

The term “linear hydrocarbon” refers to a hydrocarbon having a continuous carbon chain without side chain branching. The continuous carbon chain may be optionally substituted. The optional substitution can include replacement of at least one hydrogen atom with a functional group, such as hydroxyl, acid, amine, or halogen group; and/or replacement of at least one carbon atom with a heteroatom.

The term “branched hydrocarbon” refers to a hydrocarbon having a linear carbon chain containing branches, such as substituted and/or unsubstituted hydrocarbyl branches, bonded to the linear carbon chain. Optionally, the linear carbon chain can contain additional substitution. Optional additional substitutions can include replacement of at least one carbon atom in the linear carbon chain with a heteroatom and/or replacement of at least one hydrogen atom directly bonded to a carbon atom of the linear chain with a functional group, such hydroxyl, acid, amine, or halogen group.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The polymer of the present invention can “comprise,” “consist(s) essentially of,” or “consist of” particular groups, compositions, etc. disclosed throughout the specification. In one aspect of the present invention, and with reference to the transitional phrase “consist(s) essentially of” or “consisting essentially of,” a basic and novel characteristic of the present invention can include the polymer containing the repeating units of Formula I and/or can have a melt temperature (Tₘ) of 40° C. or higher and/or can be chemically recycled to its building blocks or monomeric units in a relatively efficient manner (e.g., contacted with aqueous and/or alcohol solutions).

All publications mentioned herein are incorporated herein by reference to disclose and describe the methods and/or materials in connection with which the publications are cited.

Other objects, features and advantages of the present invention will become apparent from the following detailed description and examples. It should be understood, however, that the detailed description and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

In the context of the present invention, at least the following 23 aspects are described. Aspect 1 is directed to a polymer comprising repeating units of Formula I:

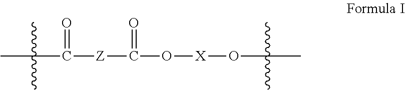

X is an aliphatic group, and
Z is an aliphatic group comprising at least 45 carbon atoms, preferably 45 to 1,000 carbon atoms, and has a degree of saturation of 98 to 100%, and
wherein the polymer has a melt temperature (Tₘ) of 40° C. to 180° C.

Aspect 2 is directed to the polymer of aspect 1, wherein Z is a linear or branched hydrocarbon having a degree of branching (DB) of 0 to 10%.

Aspect 3 is directed to the polymer of any one of aspects 1 to 2, wherein Z is a branched hydrocarbon comprising C₁ to C₁₀ hydrocarbon branches.

Aspect 4 is directed to the polymer of any one of aspects 1 to 3, wherein Z comprises a polyethylene, poly(ethylene-co-propylene), poly(ethylene-co-1-butene), poly(ethylene-co-1-hexene), or poly(ethylene-co-1-octene) group.

Aspect 5 is directed to the polymer of aspect 4, wherein Z comprises a linear or branched polyethylene group.

Aspect 6 is directed to the polymer of aspect 1, wherein Z comprises polypropylene group, such as an atactic, isotactic, or syndiotactic polypropylene group.

Aspect 7 is directed to the polymer of any one of aspects 1 to 6, wherein X comprises 45 to 1,000 carbon atoms.

Aspect 8 is directed to the polymer of any one of aspects 1 to 6, wherein X is C₁ to C₄₄ aliphatic group, preferably a C₁ to C₂₀ aliphatic group.

Aspect 9 is directed to the polymer of aspect 8, wherein X is selected from

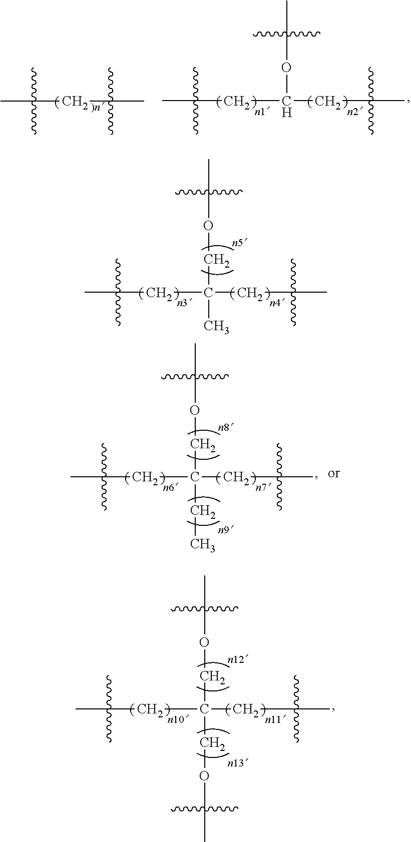

or any combination thereof
wherein n′ is an integer from 1 to 15, and denotes number of repeat units, and wherein n1′, n2′, n3′, n4′, n5′, n6′, n7′, n8′, n9′, n10′, n11′, n12′, and n13′, are independently an integer from 1 to 5, and denote number of repeat units.

Aspect 10 is directed to the polymer of any one of aspects 1 to 9, comprising a number average molecular weight of 10,000 to 1,000,000 g/mol, preferably of 20,000 to 500,000 g/mol, more preferably of 40,000 to 200,000 g/mol, said number average molecular weight being determined as the polyethylene equivalent molecular weight by high temperature size exclusion chromatography performed at 160° C. in trichlorobenzene using polyethylene standards.

Aspect 11 is directed to the polymer of aspect 1, comprising repeating units of Formula II:

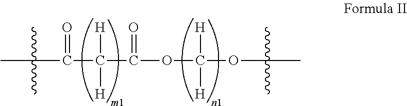

wherein,
n1 is an integer from 1 to 15 and denotes number of repeat units, and
m1 is an integer from 100 to 500 and denotes number of repeat units.

Aspect 12 is directed to the polymer of aspect 1, comprising repeating units of Formula III:

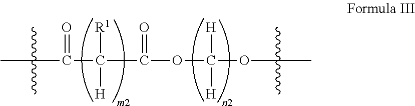

wherein,
n2 is an integer from 0 to 15 and denotes number of repeat units,
m2 is an integer from 100 to 520 and denotes number of repeat units,
R¹ is-H or —CH₂CH₃, and varies independently between H and CH₂CH₃ in the repeating units —CHR¹—, and
—(CHR¹)ₘ₂ group has a DB of 0.1 to 5%.

Aspect 13 is directed to the polymer of aspect 1, comprising the chemical formula of Formula IV

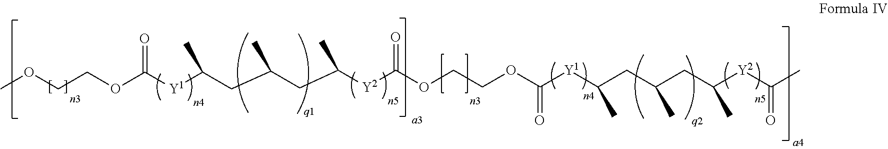

wherein n3 is an integer from 0 to 14 and denotes number of repeat units,
q1 and q2 are independently an integer from 25 to 200 and denote number of repeat units,
n4 and n5 are independently 0 or 1,
Y¹ and Y² are independently a C₁-C₁₀ hydrocarbon, and
a3 and a4 are independently an integer and denotes number of repeat units.

Aspect 14 is directed to the polymer of aspect 1, comprising repeating units of a first unit having the formula of Formula I, and repeating units of a second unit having the formula of Formula I, wherein X of the first unit has a different chemical formula than the X of the second unit.

Aspect 15 is directed to a method for forming the polymer of any one of aspects 1 to 14, the method comprising:
reacting a α,ω-dicarboxylic acid compound having a formula of HO₂C—Z—CO₂H or an ester thereof, with a α,ω-dihydroxy compound having a formula of Formula V, wherein Z is an aliphatic group comprising at least 45 carbon atoms, preferably 45 to 1,000 carbon atoms, and has a degree of saturation of 98 to 100%, wherein Formula V is

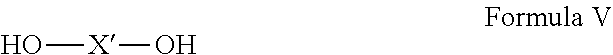

wherein X′ is an aliphatic group.

Aspect 16 is directed to the method of aspect 15, wherein X′ is selected from

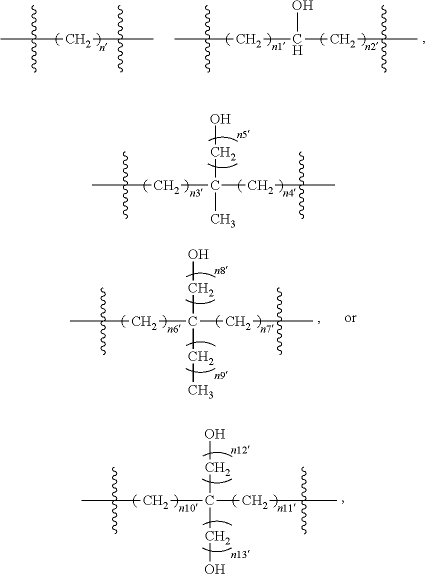

or any combination thereof
wherein n′ is an integer from 1 to 15, and denotes number of repeat units, and wherein n1′, n2′, n3′, n4′, n5′, n6′, n7′, n8′, n9′, n10′, n1l′, n12′, and n13′, are independently an integer from 1 to 5, and denote number of repeat units.

Aspect 17 is directed to the method of aspect 15, wherein the α,ω-dihydroxy compound is ethylene glycol, 1,3-propanediol, 1,4-butanediol, 1,6-hexanediol, 1,2-cyclohexanediol, 2-butene-1,4-diol, glycerol, trimethalolmethane, trimethalolethane, trimethalolpropane, 3-hydroxymethyl-1,5-pentanediol, pentaerythritol, or any combinations thereof.

Aspect 18 is directed to the method of any one of aspects 14 to 17, wherein the ester is methyl, ethyl and/or propyl ester.

Aspect 19 is directed to the method of any one of aspects 14 to 18, wherein the α,ω-dihydroxy compound is reacted with the α,ω-dicarboxylic acid compound or ester thereof at i) a temperature of 90 to 250° C., and/or ii) under inert atmosphere and/or vacuum.

Aspects 20 is directed to a method for recycling a polymer of any one of aspects 1 to 14, the method comprising contacting the polymer with water and/or an alcohol under conditions suitable to depolymerize the polymer through hydrolysis and/or alcoholysis to produce a α,ω-dicarboxylic acid compound having a formula of HO₂C—Z—CO₂H or ester thereof, and an α,ω-dihydroxy compound having a formula of Formula V,
wherein Z is an aliphatic group comprising at least 45 carbon atoms, preferably 45 to 1,000 carbon atoms, and has a degree of saturation of 98 to 100%, wherein Formula V is

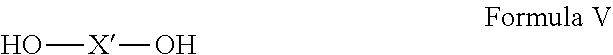

wherein X′ is an aliphatic group.

Aspect 21 is directed to a composition comprising a polymer of any one of aspects 1 to 14.

Aspect 22 is directed to the composition of aspect 21, wherein the composition is comprised in an article of manufacture.

Aspect 23 is directed to any of the aspects wherein the α,ω-dicarboxylic acid compound is sebacic acid, succinic acid, tetradecane dioic acid and dodecane dioic acid.

Aspect 24 is directed to any of the aspects wherein the polymer comprises 0.01 to 40 ester groups per 1000 backbone carbon units

### BRIEF DESCRIPTION OF THE DRAWINGS

FIG. 1 shows the SSNMR of the polymer of Example 1.

FIG. 2 is the differential scanning calorimetry (DSC) data of the LLDPE mimic of Example 1.

FIG. 3 is the thermal gravimetric analysis (TGA) for the polymer produced in Example 1 in a nitrogen atmosphere.

FIG. 4 is a graph showing the % of crystallinity of the polymer of Example 1.

FIG. 5 shows the melting temperature of a co-monomer.

FIG. 6 shows the 1H-NMR results for the polymer of Example 3.

FIG. 7 is a graph of the DSC data of the poly(dodecasebacate).

FIG. 8 shows the 1H-NMR of poly(ethylenedodecanedioate).

FIG. 9 shows the DSC data of poly(ethylenedodecanedioate).

FIG. 10 shows the XRD pattern of poly(ethylene dodecanedioate).

### DETAILED DESCRIPTION OF THE INVENTION

A discovery has been made that provides a solution to at least some of the problems associated with chemical recycling of polyolefin polymers. In one aspect, the discovery can include providing a polymer that is more readily recyclable to its chemical building blocks or monomeric units when compared with existing polyolefin polymers such as polyethylene, polypropylene, and/or blends thereof. In one aspect, a polymer of the present invention can have 0.01 to 40 ester groups per 1,000 backbone C atoms and a degree of saturation higher than 97%. As illustrated in a non-limiting manner in the examples, polymers of the current invention can have polyolefin like properties and can readily be recycled to their respective monomeric units.

These and other non-limiting aspects of the present invention are discussed in further detail in the following sections.

### A. Polymer

A polymer of the present invention can contain repeating units of Formula I:

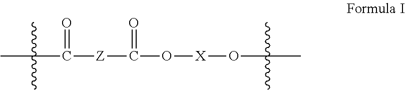

Z can be an aliphatic group. Z can contain at least 45 carbon atoms. In certain aspects, Z can vary randomly between the repeating units of Formula I, such as number of carbon atoms and/or DB of the Z groups in the polymer can vary randomly. In certain aspects, Z does not vary between the repeating units of Formula I. In some aspects, Z can contain 45 to 1,000, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms. In some aspects, average number of carbon atoms in the Z groups of the polymer can be 45 to 1000 or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000.

In some aspects, Z can be a linear hydrocarbon, such as a linear polyolefin group. In some aspects, the linear polyolefin group can have the formula of Formula (10)

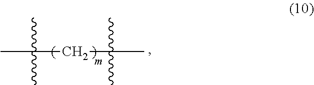 [SMILES: *C*]

where m can be an integer from 45 to 1,000, and denotes number of repeat units. In some aspects, m can be equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, m can vary randomly between the repeating units of Formula 10, and/or average of m in the polymer, can be 45 to 1,000, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, m does not vary between the repeating units of Formula 10. Formula (10a) is a non-limiting example of a polymer of the present invention, where m (e.g. the Z groups) varies randomly between the repeating units of Formula 10

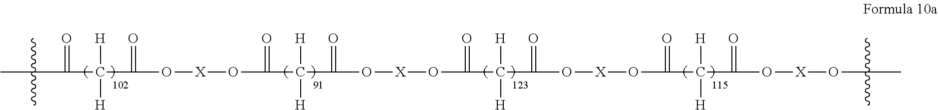

Formula (10b) is a non-limiting example of a polymer of the present invention, where m does not vary between the repeating units of Formula 10

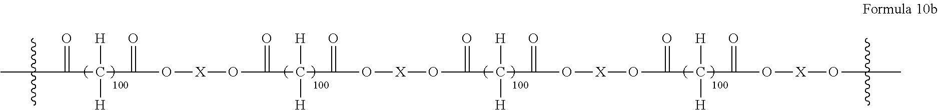

In certain aspects, Z can be a branched hydrocarbon having a degree of branching (DB) of 0.01 to 10%, or equal to any one of, at most any one of, or between any two 0.01, 0.1, 0.5, 1, 2, 3, 4, 5, 6, 7, 8, 9, and 10%. In some aspects, the Z groups in the polymer can have an average DB of 0.01 to 10%, or equal to any one of, at most any one of, or between any two 0.01, 0.1, 0.5, 1, 2, 3, 4, 5, 6, 7, 8, 9, and 10%.

In some aspects, the branched hydrocarbon can contain saturated C₁ to C₁₀ branches (e.g., on the hydrocarbon backbone). In some aspects, the branched hydrocarbon can contain C₁ to C₁₀ alkyl group branches. In some aspects, Z can be a polyolefin having the formula of Formula (11):

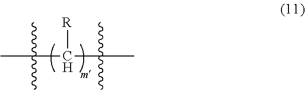

where m′ can be an integer from 45 to 1,000 and denotes number of repeat units, and R can be —H or a C₁ to C₁₀ alkyl group, and varies independently (e.g. between —H and the C₁ to C₁₀ alkyl group) in the repeating units —CHR—, wherein the —(CHR)_{m′}— group has a DB of 0.01 to 10%, or equal to any one of, at most any one of, or between any two of 0.01, 0.1, 1, 2, 3, 4, 5, 6, 7, 8, 9 and 10%. In some aspects, m′ can be equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. For example, Formula (IIa) is a non-limiting example of a polyolefin group with the formula (11), where R is-H or —CH₂CH₃, and R varies independently between —H and the —CH₂CH₃ in the repeating units —CHR—,

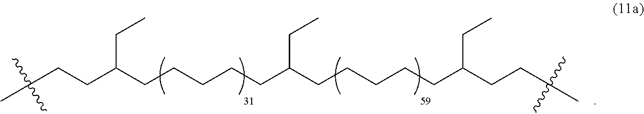

In some aspects, R can be —H or —CH₃. In some aspects, R can be —H or —CH₂CH₃. In some aspects, R can be —H or a C₃ alkyl group. In some aspects, R can be —H or a C₄ alkyl group. In some aspects, R can be —H or a C₅ alkyl group. In some aspects, R can be —H or a C₆ alkyl group. In some aspects, R can be —H or a C₇ alkyl group. In some aspects, R can be —H or a C₈ alkyl group. In some aspects, R can be —H or a C₉ alkyl group. In some aspects, R can be —H or a C₁₀ alkyl group.

In some aspects, m′ can vary randomly between the repeating units of Formula 11, and/or average of m's in the polymer can be, 45 to 1,000, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, DB of the —(CHR)_{m′}— groups can vary randomly between the repeating units of Formula 11, and/or average DB of the —(CHR)_{m′}— groups in the polymer can be 0.01 to 10%, or equal to any one of, at most any one of, or between any two of 0.01, 0.1, 1, 2, 3, 4, 5, 6, 7, 8, 9 and 10%.

In some aspects, Z can be a polyethylene, poly(ethylene-co-propylene), or poly(ethylene-co-α-olefin) group, having a DB and/or average DB of 0 to 10%, or equal to any one of, at most any one of, or between any two of 0, 0.01, 0.1, 0.5, 1, 2, 3, 4, 5, 6, 7, 8, 9, and 10%. In some aspects, the α-olefin of the poly(ethylene-co-α-olefin) group can be propylene, 1-butene, 4-methyl-1-pentene, 1-hexene, styrene, vinylcyclohexane, 1-octene, norbornene, 5-vinyl-2-norbornene, 5-ethylidene-2-norbornene or 1-decene. In some aspects, the poly(ethylene-co-α-olefin) group can contain less than 5 mol. % of α-olefin. In some aspects, the poly(ethylene-co-α-olefin) group can contain 5 mol. % or more than 5 mol. % of α-olefin. In some aspects, Z can be a linear or branched polyethylene group. The branched polyethylene group can have DB and/or average DB of 0.01 to 10%, or equal to any one of, at most any one of, or between any two 0.01, 0.1, 0.5, 1, 2, 3, 4, 5, 6, 7, 8, 9, and 10%.

In some aspects, Z can be a poly(α-olefin) group or a poly(α-olefin-co-ethylene) group having a DB greater than 10%, such as 10% to 50%, wherein the α-olefin monomers of the poly(α-olefin) group or poly(α-olefin-co-ethylene) group contain 3 or more carbons. In some aspects, the poly(α-olefin) group can be a polypropylene group, or a polybutylene group, or a poly(propylene-co-ethylene) group. In some aspects, Z can be an atactic, isotactic, or syndiotactic polypropylene group. In some aspects, Z can be random poly(propylene-co-ethylene) group. In certain aspects, Z can be poly(propylene-co-ethylene) group containing 0.7 to 6.6 mol. % of ethylene.

Z can optionally contain one or more side functional groups. In some aspects, the one or more side functional groups can be one or more of hydroxyl, acid, amine, or halogen groups. In some aspects, the functional groups can contain hydrocarbon groups linking the functional group to the hydrocarbon backbone of Z. Z can have a degree of saturation 97 to 100%, or equal to any one of, at most any one of, or between any two 97, 97.5, 98, 98.5, 99, 99.5 and 100%.

X can be an aliphatic group. X can contain up to 1000 carbon atoms, or equal to any one of, at least any one of, or between any two of 1, 10, 15, 20, 30, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms. In certain aspects, X can contain 45 to 1000 carbon atoms. In certain aspects, X can be a C₁ to C₄₄ aliphatic group. In some particular aspects, X can be an aliphatic group containing 1, 2, 3, 4, 5, 6, 7, 8, 9, 10, 11, 12, 13, 14, 15, 16, 17, 18, 19, or 20 carbons. In some aspects, X can be a linear or a branched hydrocarbon. In some aspects, X can be a branched. In some aspects, X can be a polyolefin group. In some aspects, X can be a linear polyolefin group. In some aspects, X can be a branched polyolefin group hydrocarbon having a DB of 0.01 to 50%, or equal to any one of, at least any one of, or between any two of 0.01, 0.1, 1, 2, 3, 4, 5, 6, 7, 8, 9, 10, 15, 20, 25, 30, 35, 40, 45, and 50%. In some aspects, X can contain C₁ to C₁₀ hydrocarbon branches. In some aspects, X can be a polyethylene, poly(ethylene-propylene), poly(α-olefin), poly(α-olefin-co-ethylene), or poly(ethylene-co-α-olefin) group. In certain aspects, X can be a poly(ethylene-co-1-butene), poly(ethylene-co-1-hexene), or poly(ethylene-co-1-octene) group. In some aspects, X can be a polypropylene group, or a polybutylene group, or a poly(propylene-co-ethylene) group. In some aspects, X can be an atactic, isotactic, or syndiotactic polypropylene group. In some aspects, X can be random poly(propylene-co-ethylene) group. In some aspects, the one or more side functional groups of X can be one or more of oxy, hydroxyl, acid, amine, or halogen groups. In some aspects, the functional groups can contain hydrocarbon groups linking the functional group to the backbone of X. In certain aspects, X can vary randomly between the repeating units of Formula I. In certain aspects, i) number of carbon atoms in the X groups can vary randomly between the repeating units of Formula I or iii) the DB of the X groups can vary randomly between the repeating units of Formula I. In some aspects, average of number of carbon atoms in the X groups of the polymer can be 1 to 1000 or equal to any one of, at least any one of, or between any two of 1, 2, 3, 4, 5, 6, 7, 8, 9, 10, 11, 12, 13, 14, 15, 16, 17, 18, 19, 20, 25, 30, 35, 40, 44, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, the X groups in the polymer can have an average DB of 0.01 to 50%, or equal to any one of, at most any one of, or between any two 0.01, 0.1, 1, 2, 3, 4, 5, 6, 7, 8, 9, 10, 15, 20, 25, 30, 35, 40, 45, and 50%. In certain aspects, X does not vary between the repeating units of Formula I. In some aspects, n can be 1, X can have the formula of Formula (1), and n′ can be and/or average of n′ in the polymer can be 1 to 1000, or equal to any one of, at least any one of, or between any two of 1, 10, 15, 20, 30, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000.

In some aspects, X can have the formula of Formula (1), and the polymer can contain repeating units of Formula Ib:

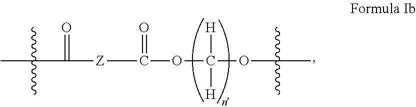

wherein n′ can be 1, 2, 3, 4, 5, 6, 7, 8, 9, 10, 11, 12, 13, 14 or 15, and denotes number of repeat units.

In some aspects, X can have the formula of Formula (2), and the polymer can contain repeating units of Formula Ic

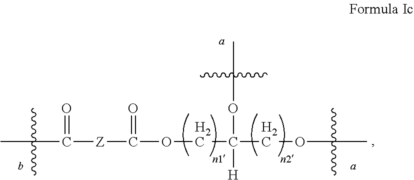

wherein the units (Formula Ic) are bonded through bonding between “a” and “b” ends, and n1′ and n2′ are independently 1, 2, 3, 4, or 5.

In some aspects, X can have the formula of Formula (3), and the polymer can contain repeating units of Formula Id:

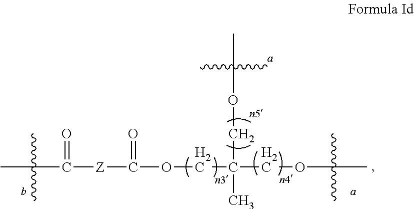

wherein the units (Formula Id) are bonded through bonding between “a” and “b” ends, and n3′, n4′ and n5′ are independently 1, 2, 3, 4, or 5.

In some aspects, X can have the formula of Formula (4), and the polymer can contain repeating units of Formula Ie:

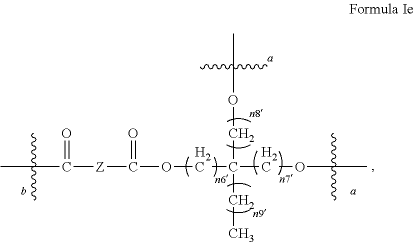

wherein the units (Formula Ie) are bonded through bonding between “a” and “b” ends, and n6′, n7′, n8′ and n9′ are independently 1, 2, 3, 4, or 5.

In some aspects, X can have the formula of Formula (5), and the polymer can contain repeating units of Formula If:

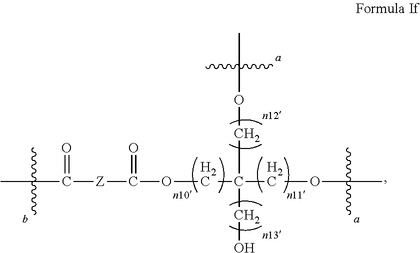

wherein the units (Formula If) are bonded through bonding between “a” and “b” ends, and n10′, n11′, n12′, and n13′ are independently 1, 2, 3, 4, or 5.

Formula (1) to (5) are described above.

In certain aspects, the polymer can contain i) repeating units of a first unit having the formula of Formula I, and ii) repeating units of a second unit having the formula of Formula I, wherein X of the first unit can have a different formula than the X of the second unit. In certain aspects, X of the first unit can be a linear hydrocarbon, and the X of the second unit can contain one or more side functional groups. In some aspects, X of the first unit has the chemical formula of Formula (1), and X of the second unit has the chemical formula of Formula (2), (3), (4) or (5). The Z of the first unit and the second unit can be same or different, e. g. can have same or different chemical formula. In some aspects, Z of the first unit and the second unit can have the same formula. In some aspects, the polymer can contain the first units and the second units arranged in blocks, randomly or in alternate. In some aspects, the first units and the second units can be arranged randomly in the polymer. In certain aspects, the ratio of mol. % of the first unit and second unit in the polymer can be 9:1 to 999:1, or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 200:1, 300:1, 400:1, 500:1, 600:1, 700:1, 800:1, 900:1, and 999:1.

The melt temperature (Tₘ) of the polymer can be equal to or greater than 40° C. In some aspects, Tₘ of the polymer can be 40° C. to 180° C., or equal to any one of, at least any one of, or between any two of 40, 45, 50, 55, 60, 65, 70, 75, 80, 85, 86, 88, 90, 92, 94, 96, 98, 100, 102, 104, 106, 108, 110, 112, 114, 116, 118, 120, 122, 124, 126, 128, 130, 132, 134, 136, 138, 140, 142, 144, 146, 148, 150, 152, 154, 156, 158, 160, 162, 164, 166, 168, 170, 175 and 180° C. The Tₘ of the polymer can be measured by differential scanning calorimetry performed at a heating rate of 10° C. per minute and wherein the melting temperature corresponds to the melting peak in a second run. In some aspects, the number average molecular weight (Mn) of the polymer can be 10,000 to 1,000,000 g/mol, or equal to any one of, at least any one of, or between any two of 10,000; 20,000; 40,000; 50,000; 60,000; 70,000; 80,000; 90,000; 100,000; 110,000; 120,000; 130,000; 140,000; 150,000; 160,000; 170,000; 180,000; 190,000; 200,000; 250,000; 300,000; 350,000; 400,000; 450,000; 500,000; 550,000; 600,000; 650,000; 700,000; 800,000; 900,000; and 1,000,000 g/mol, as determined as the polyethylene equivalent molecular weight by high temperature size exclusion chromatography performed at 160° C. in trichlorobenzene using polyethylene standards. In some aspects, the polymer can have a polydispersity index (PDI), of 1 to 4.0, or equal to any one of, at least any one of, or between any two of 1, 1.1, 1.2, 1.3, 1.4, 1.5, 1.6, 1.8, 2, 2.2, 2.4, 2.6, 2.8, 3, 3.2, 3.4, 3.6, 3.8, and 4.

In certain aspects, the polymer can contain repeating units of Formula II:

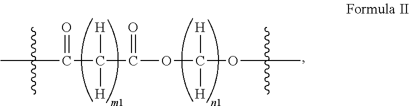

wherein n1 is 0, 1, 2, 3, 4, 5, 6, 7, 8, 9, 10, 11, 12, 13, 14 or 15, and denotes number of repeat units and wherein m1 is an integer from 100 to 700, or equal to any one of, at least any one of, or between any two of 100, 150, 200, 250, 300, 350, 400, 450, 500, 550, 600, 650 and 700, and denotes number of repeat units. In certain aspects, m1 can vary randomly between the repeating units of Formula II, and/or average of m1s of the polymer can be 100 to 700, or equal to any one of, at least any one of, or between any two of 100, 150, 200, 250, 300, 350, 400, 450, 500, 550, 600, 650 and 700. In certain aspects, m1 does not vary between the repeating units of Formula II.

In some aspects, the polymer can have repeating units of Formula III:

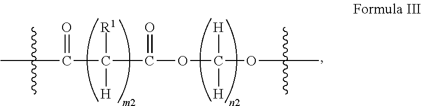

wherein n2 is 0, 1, 2, 3, 4, 5, 6, 7, 8, 9, 10, 11, 12, 13, 14 or 15, and denotes number of repeat units, and wherein m2 is an integer from 100 to 700, or equal to any one of, at least any one of, or between any two of 100, 150, 200, 250, 300, 350, 400, 450, 500, 520, 550, 600, 650 and 700, and denotes number of repeat units. R¹ can be —H or a C₁ to C₁₀ alkyl group, and varies independently (e.g. between —H and the C₁ to C₁₀ alkyl group) in the repeating units —CHR¹—, wherein the —(CHR¹)ₘ₂— group has a DB of 0.01 to 10%, or equal to any one of, at most any one of, or between any two of 0.01, 0.1, 1, 2, 3, 4, 5, 6, 7, 8, 9 and 10%. In some aspects, R¹ can be —H or —CH₃. In some aspects, R¹ can be —H or —CH₂CH₃. In some aspects, R¹ can be —H or a C₃ alkyl group. In some aspects, R¹ can be —H or a C₄ alkyl group. In some aspects, R¹ can be —H or a C₅ alkyl group. In some aspects, R¹ can be —H or a C₆ alkyl group. In some aspects, R¹ can be —H or a C₇ alkyl group. In some aspects, R¹ can be —H or a C₅ alkyl group. In some aspects, R¹ can be —H or a C₉ alkyl group. In some aspects, R¹ can be —H or a C₁₀ alkyl group. In certain aspects, m2 can vary randomly between the repeating units of Formula III, and/or the average of m2s in the polymer can be 200 to 600, or equal to any one of, at least any one of, or between any two of 100, 150, 200, 250, 300, 350, 400, 450, 500, 520, 550, 600, 650 and 700. In certain aspects, m2 does not vary between the repeating units of Formula III. In certain aspects, DB of the —(CHR¹)ₘ₂-groups can vary randomly between the repeating units of Formula III, and/or the average DB of the —(CHR¹)ₘ₂-groups in the polymer can be 0.01 to 10%, or equal to any one of, at most any one of, or between any two of 0.01, 0.1, 1, 2, 3, 4, 5, 6, 7, 8, 9 and 10%. In certain aspects, DB of the —(CHR¹)ₘ₂-groups between the repeating units of Formula III does not vary.

In certain particular aspects, i) n2 can be 2, ii) R¹ can be —H or —CH₂CH₃, varies independently (e.g. between —H and —CH₂CH₃) in the repeating units —CHR¹—, and the —(CHR¹)ₘ₂— group has a DB of 0.1 to 5%, iii)ₘ₂ can be 400 to 520, iv) Mn of the polymer can be 90,000 to 120,000 g/mol, v) Tₘ of the polymer can be ranging from 90° C. to 110° C., or any combinations thereof. In some particular aspects, i) n2 can be 2, ii) R¹ can be —H or —CH₂CH₃, varies independently (e.g. between —H and —CH₂CH₃) in the repeating units —CHR¹—, and the —(CHR¹)ₘ₂— group has a DB of 0.1 to 5%, iii)ₘ₂ can be 400 to 520, iv) Mn of the polymer can be 90,000 to 120,000 g/mol, and v) Tₘ of the polymer can be ranging from 90° C. to 110° C.

In some aspects, the polymer can have repeating units of Formula VI and Formula VII, wherein the units are bonded through bonding between “a” and “b” ends:

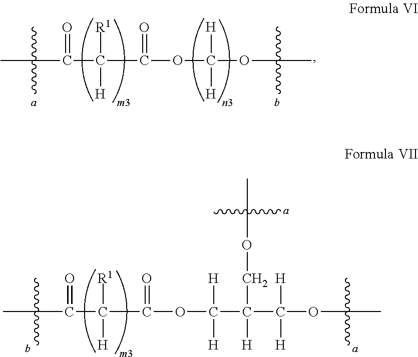

wherein n3 is 0, 1, 2, 3, 4, 5, 6, 7, 8, 9, 10, 11, 12, 13, 14 or 15, and denotes number of repeat units, wherein m3 in Formula VI and VII can independently be an integer from 100 to 700, or equal to any one of, at least any one of, or between any two of 100, 150, 200, 250, 300, 350, 400, 450, 500, 520, 550, 600, 650 and 700, and denotes number of repeat units. R¹ in Formula VI and VII can independently be —H or a C₁ to C₁₀ alkyl group, and varies independently (e.g. between —H and the C₁ to C₁₀ alkyl group) in the repeating units —CHR¹—, wherein the —(CHR¹)ₘ₃-groups in Formula VI and VII can independently have a DB of 0.01 to 10%, or equal to any one of, at most any one of, or between any two of 0.01, 0.1, 1, 2, 3, 4, 5, 6, 7, 8, 9 and 10%. In some aspects, R¹ can be —H or —CH₃. In some aspects, R¹ can be —H or —CH₂CH₃. In some aspects, R¹ can be —H or a C₃ alkyl group. In some aspects, R¹ can be —H or a C₄ alkyl group. In some aspects, R¹ can be —H or a C₅ alkyl group. In some aspects, R¹ can be —H or a C₆ alkyl group. In some aspects, R¹ can be —H or a C₇ alkyl group. In some aspects, R¹ can be —H or a C₅ alkyl group. In some aspects, R¹ can be —H or a C₉ alkyl group. In some aspects, R¹ can be —H or a C₁₀ alkyl group. In certain aspects, m3 can vary randomly between the repeating units of Formula VI. In certain aspects, m3 can vary randomly between the repeating units of Formula VII. In certain aspects, m3 does not vary between the repeating units of Formula VI. In certain aspects, m3 does not vary between the repeating units of Formula VII. In certain aspects, DB of the —(CHR¹)ₘ₃-groups can vary randomly between the repeating units of Formula VI. In certain aspects, DB of the —(CHR¹)ₘ₃-groups can vary randomly between the repeating units of Formula VII. In certain aspects, DB of the —(CHR¹)ₘ₃-groups do not vary between the repeating units of Formula VI. In certain aspects, m3 does not vary between the repeating units of Formula VII. The units of Formula VI and Formula VII can be randomly located in the polymer, and can have a mol. ratio of 9:1 to 999:1.

### B. Method of Forming the Polymer

Certain aspects are directed to a method for forming a polymer described herein. The method can include reacting an α,ω-dicarboxylic acid compound having a formula of HO₂C—Z—CO₂H, or the ester thereof with a α,ω-dihydroxy compound having a formula of Formula V. In some aspects, the ester (e.g. of the acid having the formula of HO₂C—Z—CO₂H) can be methyl, ethyl and/or propyl ester. Z can have a structure as described above. The structure of Formula V can be:

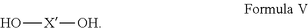

X′ can be an aliphatic group. X′ can and/or on average contain up to 1000 carbon atoms, or equal to any one of, at most any one of, or between any two of 1, 10, 15, 20, 30, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms. In certain aspects, X′ can contain 45 to 1000 carbon atoms. In certain aspects, X can be a C₁ to CH aliphatic group. In some particular aspects, X′ can be an aliphatic group containing 1, 2, 3, 4, 5, 6, 7, 8, 9, 10, 11, 12, 13, 14, 15, 16, 17, 18, 19, or 20 carbons. In some aspects, X′ can be a linear or a branched hydrocarbon. In some aspects, X′ can be a branched hydrocarbon. In some aspects, X′ can be a polyolefin group. In some aspects, X′ can be a linear polyolefin group. In some aspects, X′ can be a branched polyolefin group having a DB of, and/or an average DB of 0.01 to 50%, or equal to any one of, at least any one of, or between any two of 0.01, 0.1, 1, 2, 3, 4, 5, 6, 7, 8, 9, 10, 15, 20, 25, 30, 35, 40, 45, and 50%. In some aspects, X can contain C₁ to C₁₀ hydrocarbon branches. In some aspects, X′ can be a polyethylene, poly(ethylene-propylene), poly(α-olefin), poly(α-olefin-co-ethylene), or poly(ethylene-co-α-olefin) group. In certain aspects, X can be a poly(ethylene-co-1-butene), poly(ethylene-co-1-hexene), or poly(ethylene-co-1-octene) group. In some aspects, X′ can be a polypropylene group, or a polybutylene group, or a poly(propylene-co-ethylene) group. In some aspects, X′ can be an atactic, isotactic, or syndiotactic polypropylene group. In some aspects, X′ can be random poly(propylene-co-ethylene) group. In some aspects, X′ can contain one or more side functional groups. In some aspects, the one or more side functional groups can be one or more of oxy, hydroxyl, acid, amine, or halogen groups. In some aspects, the functional groups can contain hydrocarbon groups linking the functional group to the backbone of X′. In some aspects, X′ can have the formula of formula (1), (6), (7), (8), or (9) or any combination thereof. In some aspects, the α,ω-dihydroxy compound (e.g., of Formula V) can be ethylene glycol, 1,3-propanediol, 1,4-butanediol, 1,6-hexanediol, 1,2-cyclohexanediol, 2-butene-1,4-diol, glycerol, trimethalolmethane, trimethalolethane, trimethalolpropane, 3-hydroxymethyl-1,5-pentanediol, pentaerythritol, or any combinations thereof.

In some aspects, the HO₂C—Z—CO₂H and/or the ester thereof can be reacted with the α,ω-dihydroxy compound (e.g., of Formula V) at i) a temperature of 90 to 250° C., or equal to any one of, at least any one of, or between any two of 90, 100, 110, 120, 130, 140, 150, 160, 170, 180, 190, 200, 210, 220, 230, 240, and 250° C. and/or ii) under inert atmosphere and/or vacuum. In some aspects, the reaction can include esterification at 90 to 250° C., and/or under inert atmosphere, followed by polycondensation at 90 to 250° C., and/or under vacuum, e.g. at pressure below 0.5 mbarg, such as below 0.1 mbarg, such as around 0.05 mbarg. The HO₂C—Z—CO₂H and/or the ester thereof can be reacted with the α,ω-dihydroxy compound (e.g., of Formula V) at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, and 95:05.

In some aspects, the method can include reacting the α,ω-dicarboxylic acid compound HO₂C—Z—CO₂H and/or the ester thereof with i) a first α,ω-dihydroxy compound having the formula of Formula V, and ii) a second α,ω-dihydroxy compound having the formula of Formula V, wherein X′ of the Formula V of the first α,ω-dihydroxy compound is different than the X′ of the Formula V of the second α,ω-dihydroxy compound. In some aspects, the X′ of the Formula V of the first α,ω-dihydroxy compound can be a linear hydrocarbon, and the X′ of the Formula V of the second α,ω-dihydroxy compound can contain one or more side functional groups. In some aspects, X′ of the Formula V of the first α,ω-dihydroxy compound has the formula of formula (1), and X′ of the Formula V of the second α,ω-dihydroxy compound has the formula of formula (6), (7), (8), or (9). In some aspects, the first α,ω-dihydroxy compound can be ethylene glycol, 1,3-propanediol, 1,4-butanediol, 1,6-hexanediol, 1,2-cyclohexanediol, 2-butene-1,4-diol, or any combinations thereof. In some aspects, the second α,ω-dihydroxy compound can be glycerol, trimethalolmethane, trimethalolethane, trimethalolpropane, 3-hydroxymethyl-1,5-pentanediol, pentaerythritol, or any combinations thereof. In certain aspects, the compound HO₂C—Z—CO₂H and/or the ester thereof can be polymerized with more than two of α,ω-dihydroxy compounds selected from ethylene glycol, 1,3-propanediol, 1,4-butanediol, 1,6-hexanediol, 1,2-cyclohexanediol, 2-butene-1,4-diol, glycerol, trimethalolmethane, trimethalolethane, trimethalolpropane, 3-hydroxymethyl-1,5-pentanediol, pentaerythritol.

In some aspects, the α,ω-dicarboxylic acid compound HO₂C—Z—CO₂H and/or the ester thereof can be reacted with the a) first α,ω-dihydroxy compound, and b) the second α,ω-dihydroxy compound, at i) a temperature of 90 to 250° C., or equal to any one of, at least any one of, or between any two of 90, 100, 110, 120, 130, 140, 150, 160, 170, 180, 190, 200, 210, 220, 230, 240, and 250° C. and/or ii) under inert atmosphere and/or vacuum. In some aspects, the reaction (e.g. of HO₂C—Z—CO₂H and/or ester thereof with the first α,ω-dihydroxy compound, and the second α,ω-dihydroxy compound) can include esterification at 90 to 250° C., and/or under inert atmosphere, followed by polycondensation at 90 to 250° C., and/or under vacuum, e.g. at pressure below 0.5 mbarg, such as below 0.1 mbarg, such as around 0.05 mbarg. The HO₂C—Z—CO₂H and/or the ester thereof can be reacted with the first α,ω-dihydroxy compound at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, and 95:05. The first α,ω-dihydroxy compound and the second α,ωdihydroxy compound can be reacted with the HO₂C—Z—CO₂H and/or the ester thereof at a first α,ω-dihydroxy compound: second α,ω-dihydroxy compound mole ratio of 9:1 to 999:1, or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 200:1, 300:1, 400:1, 500:1, 600:1, 700:1, 800:1, 900:1, and 999:1.

In some aspects, the α,ω-dicarboxylic acid compound HO₂C—Z—CO₂H a have greater than 45 carbons, e.g., 46, 50, 100 or 1000 carbons. In other aspects, the diol will contain 6 or less carbon atoms, e.g., 1, 2, 3, 4 or 5 carbon atoms linking the hydroxyl groups. In certain aspects, these two features are combined. A particularly preferred diol is ethylene glycol.

Preferred α,ω-dicarboxylic acid compounds include sebacic acid, succinic acid, tetradecane dioic acid and dodecane dioic acid.

In certain aspects, the reaction, (e.g., esterification and/or polycondensation of HO₂C—Z—CO₂H and/or the ester thereof with the α,ω-dihydroxy compound; or of HO₂C—Z—CO₂H and/or ester thereof with the first α,ω-dihydroxy compound, and the second α,ω-dihydroxy compound) can be performed in presence of a catalyst. In some aspects, catalyst used can include but are not limited to a mineral acid, organic acid, organic base, and/or metallic compound. In some aspects, the metallic compound can be a hydrocarbyl, oxide, chloride, carboxylate, alkoxide, aryloxide, amide, salen complex, β-ketiminato complex, or guanidinato complex, of a metal. In some aspects, the metal can be Li, Na, K, Mg, Ca, Sc, Y, lanthanides, Ti, Zr, Zn, Mo, Mn, Al, Ga, Bi, Sb, or Sn. In some aspects, the catalyst can be Ti(OiPr)₄, Ti(OBu)₄, Al(OiPr)₃, Sn(2-ethyl-hexanoate)₂, MoO₃, or any combinations thereof. In certain aspects, a combination of catalyst can be used.

A non-limiting general example method for production of polyolefin like polyester polymers is as follows: A multistep synthesis was performed to produce an unsaturated branched polybutadiene diol of the invention. Prior to polymerization, all the glassware were carefully oven dried and charged with argon. The experiment will be performed in an inert controlled atmosphere.

A diacid (12) having a hydrocarbon backbone containing —CH₂CH₃ branches and a mol. wt. of ˜6,332 g/mol. can be polymerized with ethylene glycol to obtain the polymer (13). x and y in formula (12) and (13) can be mole fractions and can have a ratio of 97:3.

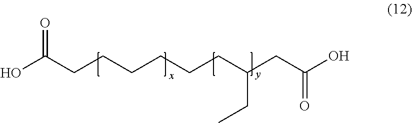

The diacid (12) can be polymerized, via esterification and polycondensation, with ethylene glycol using titanium tetra-isopropoxide. The esterification can be carried out at 190° C. for a period of 2.5 h under nitrogen atmosphere followed by polycondensation for 5 h at 220° C. at 0.05 mbarg. The polymer (13) can have polyolefin like properties. In formula (13) a is an integer denotes number of repeat units.

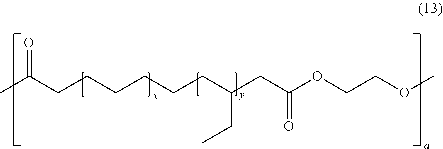

### C. Method of Recycling the Polymer

Certain aspects, are directed to a method for recycling a polymer described herein. The recycling can include, depolymerizing the polymer. The polymer can be depolymerized to obtain a α,ω-dicarboxylic acid compound having a formula of HO₂C—Z—CO₂H and/or the ester thereof. In certain aspects, the depolymerization method can include hydrolysis and/or alcoholysis of the polymer to obtain the compound of formula HO₂C—Z—CO₂H (e.g., via hydrolysis) and or the ester thereof (e.g., via alcoholysis), and the α,ω-dihydroxy compound of Formula V. In certain aspects, the depolymerization of the polymer can produce i) the compound HO₂C—Z—CO₂H and/or the ester thereof, ii) a first α,ω-dihydroxy compound having a formula of Formula V and iii) a second α,ω-dihydroxy compound having the formula of Formula V, wherein X′ of the Formula V of the first α,ω-dihydroxy compound is different than the X′ of the Formula V of the second α,ω-dihydroxy compound. In some aspects, the X′ of the Formula V of the first α,ω-dihydroxy compound can be a linear hydrocarbon, and the X′ of the Formula V of the second α,ω-dihydroxy compound can contain one or more side functional groups. In some aspects, X′ of the Formula V of the first α,ω-dihydroxy compound has the formula of formula (1), and X′ of the second a, @-dihydroxy compound has the formula of formula (6), (7), (8), or (9). In some aspects, the first α,ω-dihydroxy compound can be ethylene glycol, 1,3-propanediol, 1,4-butanediol, 1,6-hexanediol, 1,2-cyclohexanediol, 2-butene-1,4-diol, or any combinations thereof. In some aspects, the second α,ω-dihydroxy compound can glycerol, trimethalolmethane, trimethalolethane, trimethalolpropane, 3-hydroxymethyl-1,5-pentanediol, pentaerythritol, or any combinations thereof. In certain aspects, the depolymerization method can include methanolysis of the polymer under conditions suitable to obtain the methyl ester of a compound of formula HO₂C—Z—CO₂H, and a α,ω-dihydroxy compound of Formula. In some aspects, the methanolysis conditions can include i) a temperature of 100° C. to 250° C., or equal to any one of, at least any one of, or between any two of 100, 110, 120, 130, 140, 150, 160, 170, 180, 190, 200, 210, 220, 230, 240, and 250° C. and/or ii) a pressure of 10 barg to 60 barg, or equal to any one of, at least any one of, or between any two of 10, 15, 20, 25, 30, 35, 40, 45, 55 and 60 barg. In some aspects, the depolymerization can be performed at an inert atmosphere. Catalyst used for depolymerization, such as methanolysis can include a mineral acid, organic acid, organic base, and/or metallic compound. In some aspects, the metallic compound can be a hydrocarbyl, oxide, chloride, carboxylate, alkoxide, aryloxide, amide, salen complex, β-ketiminato complex, or guanidinato complex, of a metal. In some aspects, the metal can be Li, Na, K, Mg, Ca, Sc, Y, lanthanides, Ti, Zr, Zn, Mo, Mn, Al, Ga, Bi, Sb, or Sn. In some aspects, the catalyst can be Ti(OiPr)₄, Ti(OBu)₄, Al(OiPr)₃, Sn(2-ethyl-hexanoate)₂, MoO₃, or any combinations thereof.

In certain aspects, the method of recycling can include repolymerization of the recycled HO₂C—Z—CO₂H and/or the ester thereof, e.g., obtained from the depolymerization process. The recycled HO₂C—Z—CO₂H and/or the ester thereof can be repolymerized to form a polymer described herein. In some aspects, the recycled HO₂C—Z—CO₂H and/or the ester thereof can be repolymerized with an α,ω-dihydroxy compound having the formula of Formula V. In some aspects, the recycled HO₂C—Z—CO₂H and/or ester thereof can be repolymerized with i) a first α,ω-dihydroxy compound having the formula of Formula V, ii) a second α,ω-dihydroxy compound having the formula of Formula V, wherein X′ of the Formula V of the first α,ω-dihydroxy compound is different than the X′ of the Formula V of the second α,ω-dihydroxy compound.

### D. Compositions and Article of Manufacture Containing the Polymer

The polymers described herein can be included in a composition. In some aspects, the composition can contain a blend of the polymer (e.g., containing repeating units of formula I) and one or more other polymers. In some aspects, the one or more other polymers can be polyethylene, polypropylene, polystyrene, polyethylene terephthalate, polybutylene terephthalate, polybutylene succinate, polybutylene adipate, polyvinyl acetate, ethyl vinyl alcohol, poly(methyl acrylate), poly(methyl methacrylate), polypropylene carbonate, bisphenol A polycarbonate, polysulphonate, polyurethanes, polyamides, synthetic rubber, mineral oils, or any combinations thereof. In some aspects, the composition can further include one or more additives. The one or more additives may include, but are not limited to, a scratch-resistance agent, an antioxidant, a flame retardant, an UV absorber, a photochemical stabilizer, a filler such as glass and/or mineral filler, an optical brightener, a surfactant, a processing aid, a mold release agent, a pigment, flow modifiers, foaming agents or any combinations thereof. In some aspects, the compositions can be comprised in or in the form of a foam, a film, a layer, a sheet, a molded article, a welded article, a filament, a fiber, a wire, a cable, or a powder. In one example, the composition is incorporated into a film. Specifically, the film may include at least one film layer that includes the composition. In further aspects the film includes at least a second film layer.

Certain aspects are directed to an article of manufacture containing a polymer described herein and/or a composition containing the polymer. The composition and/or article of manufacture can be molded, such as extruded, injection molded, blow molded, compression molded, rotational molded, thermoformed and/or 3-D printed article. In some aspects, the article of manufacture can be a personal equipment part, an automobile part, plumbing material, construction material, a consumer electronics housing, a personal equipment part, a kitchen appliance, furniture, or a home appliance component.

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

### Example 1

Reaction of (α,ω-dicarboxyl hydrogenated polybutadiene,) with ethylene glycol.

Step 1 (esterification): In a first synthesis step a diacid, 3.6 mmol α,ω-dicarboxyl hydrogenated polybutadiene having approximately 20 mol. % branching, 4.7 mmol ethylene glycol and 0.12 gram titanium tetra-isopropoxide (1 wt. % of polymer) were introduced into a reactor. The mixture is then heated to 190° C. while stirring under for 2.5 hrs a nitrogen atmosphere at atmospheric pressure.

The diacid used for esterification has the following properties:

$$Molecular weight of {M}_{n} = 5000$$

a degree of branching of approximately 20% with C₂, which is within the range (0.0001-12)

$$a degree of hydrogenation > \sim 99.5 \% ( within the range > 97 \% )$$

Carbon chain length for branching is C₁-C₁₂, and preferably is C₂

Step 2 (polycondensation): After the first step a polycondensation was initiated by turning off the nitrogen and by gradually reducing the pressure down to approximately 0.05 mbar. The temperature was raised to 220° C. The polycondensation reaction was conducted for 6.0 hrs, and the vacuum was released by bleeding in the nitrogen gas. The resultant polymer was collected.

The overall procedure is shown in Scheme I below:

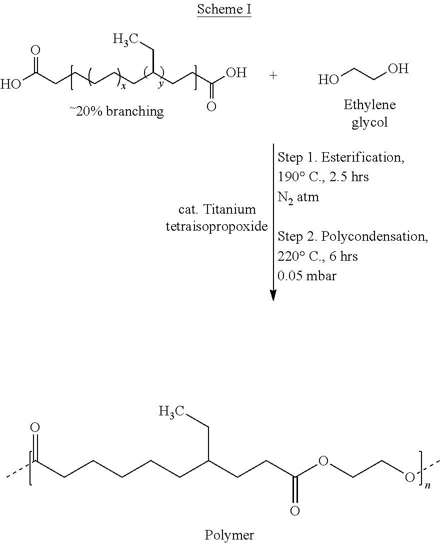

In Scheme I, x=120; y=20; and n is at least 2, preferably from 2 to 10,000. Note also that for this scheme the branching group shown is C₂ simply for illustrative purposes, but may be a C₁ to C₁₂

### Results For Example 1

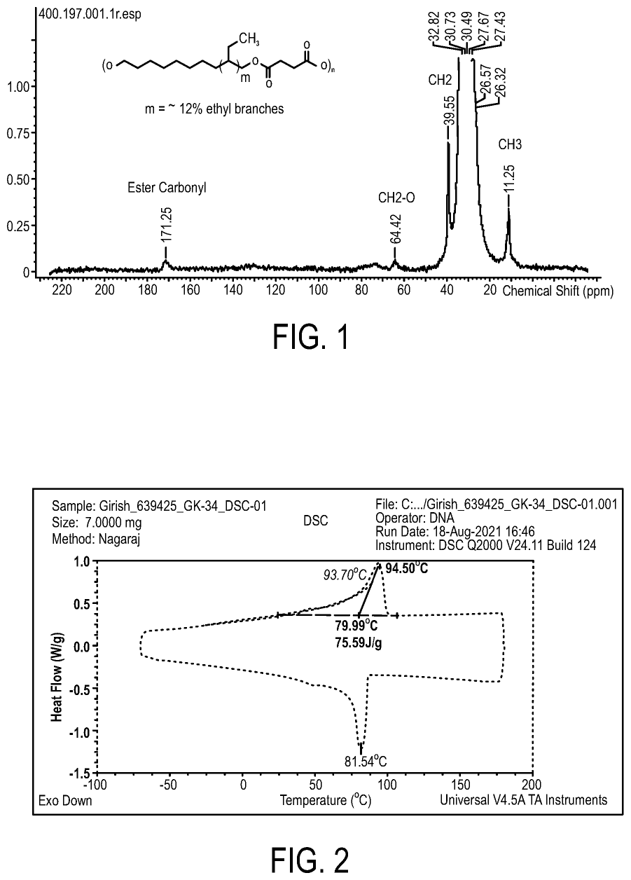

The resultant polymer of Example 1, a linear low-density polyethylene (LLDPE) mimic, was characterized by SSNMR as shown in FIG. 1.

Differential scanning calorimetry (DSC) data of the LLDPE mimic of Example 1 is shown in FIG. 2. For Example 1, the DSC data showed a Tₘ and T_{c} of 94° C., 82° C. respectively.

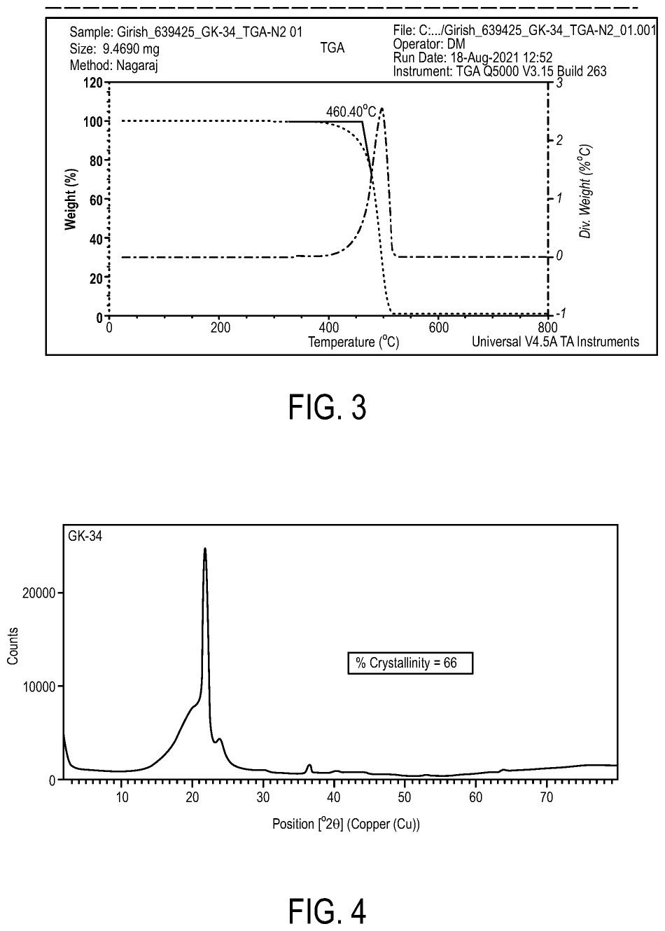

The thermal gravimetric analysis (TGA) for the polymer produced in Example 1 in a nitrogen atmosphere was found to be 460° C. and is shown in FIG. 3.

The % of crystallinity of the polymer of Example 1 was found to be 66% and is shown in FIG. 4. Peaks at 2θ˜ 21.7° and 2θ˜23.8° due to (110) and (200) reflections, are characteristic peaks of polyethylene. A weak/broad shoulder band at ˜19⁰ represents a semi-amorphous phase.

The table below sets forth important characteristics of the diacid, the diol and the polymer of Example 1:
1. The ester to thousand methylene unit ratio (example 2) was 4.2 within the range of 0.0001 to 40;
2. Ethylene branching which is 2 carbon atoms branch (within the range (C₁-C₁₂)
3. degree of branching of ˜ 65 mol % (see graph below) (desired range 0-12 mol %)
4. Degree of hydrogenation >˜99.5% (within the range >97%), thus making a good example of LLDPE-mimic material.

| | DIACID | | | | | | | | |
|---|---|---|---|---|---|---|---|---|---|
| | Molecular | | | | | | | | |
| | Weight | | Degree of | Branching | Degree of | | | Polymer of Ex. 1 | |
| | [M_{w}] | | Branching | Carbon | hydrogenation | DioL | | —COO/1000 | |
| Example | (g/mol) | Functionality | (y %) | Length | (%) | (CH₂) | COOH | (CH₂) | T_{M} |
| 1 (Invention Direct) | 5000 | —COOH | ~20% | 2 | 99.5 | 2 | 2 | 5.4 | 94 |

The results show that the polymer had an aliphatic group of 472 carbon atoms (at least 45), a degree of saturation of 98%, and a melt temperature of 94.6° C. (within the range of (Tₘ) of 40° C. to 180° C.).

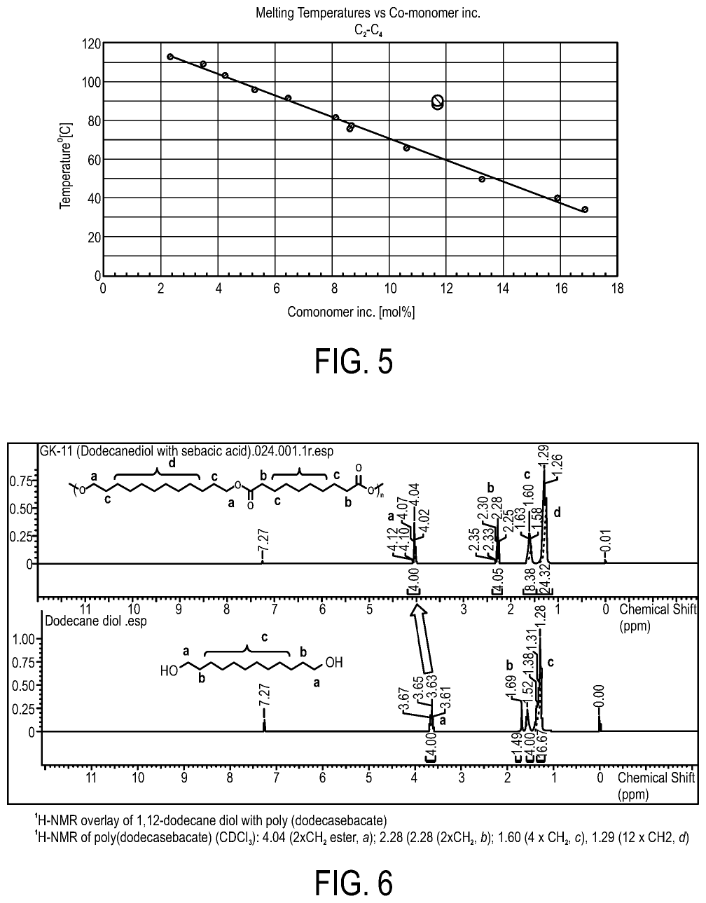

The melting temperature of the co-monomer is shown in FIG. 5.

### Example 2

The purpose of this Example is to evaluate a linear diacid that is prepared to produce an HDPE-Mimic.

### Materials

The following diol and diacid were selected:

| | | | | Degree of | | |
|---|---|---|---|---|---|---|
| | | | | Branching (mol | Branching | Degree of |
| Material | Description | Source | Mw | %) | Carbon Length | Hydrogenation |
| Diacid | Custom | | 3000 | 0 | 0 | >98% |
| | Synthesis | | | | | |
| Diol | Ethylene | SABIC | ~63 | 0 | 0 | 100% |
| | Glycol | | | | | |

### Procedure

The diacid for this example was synthesized from alpha omega divinyl polyethylene to form the diacid according to the following general scheme where m is 211:

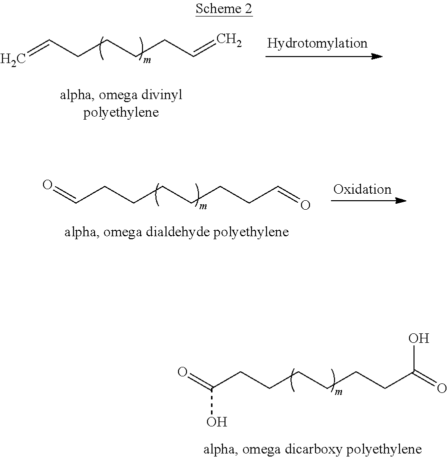

The resultant diacid was then reacted with ethylene glycol in a two-step process to form the desired polymer as follows:

Step I—Esterification reaction: 8.2 mmol α,ω-dicarboxy polyethylene, 10.7 mmol ethylene glycol and 0.12 g titanium tetra-isopropoxide were introduced into a reactor. The reactor was then heated to 190° C. while stirring, and in a nitrogen atmosphere. The esterification was carried out in the reactor for 2.5 hrs at atmospheric pressure and at 190° C.

Step II-Polycondensation reaction: After Step I, polycondensation was started by stopping the nitrogen flow and by gradually reducing the pressure down to approximately 0.05 mbar, and raising the temperature to 220° C. The polycondensation reaction was conducted for 3.0 hrs, the vacuum was released by bleeding in nitrogen. The resultant polymer was collected.

The reaction scheme for this experiment is shown below where m is 211:

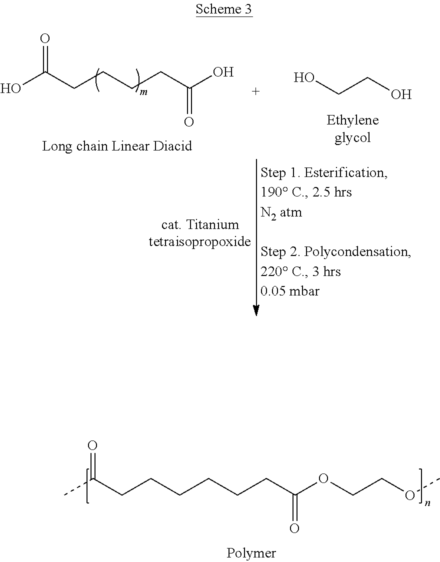

### Example 3

Step I-esterification-59.3 mmol α,ω-dicarboxy polyethylene, ethylene (61.3 mmol) and titanium tetra-isopropoxide (0.29 g) were introduced into the reactor and the reactor was then heated to 190° C. while stirring and in the presence of a nitrogen atmosphere. The first stage was conducted for 3.0 hrs at atmospheric pressure.

Step II-After step I, polycondensation was started by stopping the nitrogen flow and by gradually reducing the pressure down to ˜0.05 mbar and the temperature was raised to 220° C. After polycondensation reaction for 4.0 hrs, the vacuum was released by bleeding in nitrogen, and the polymer was collected.

The linear diacid (α,ω-dicarboxy polyethylene) used has approximately 212 (CH₂) units.

The resultant polymer of Example 3 was characterized by 1H-NMR as shown in FIG. 6.

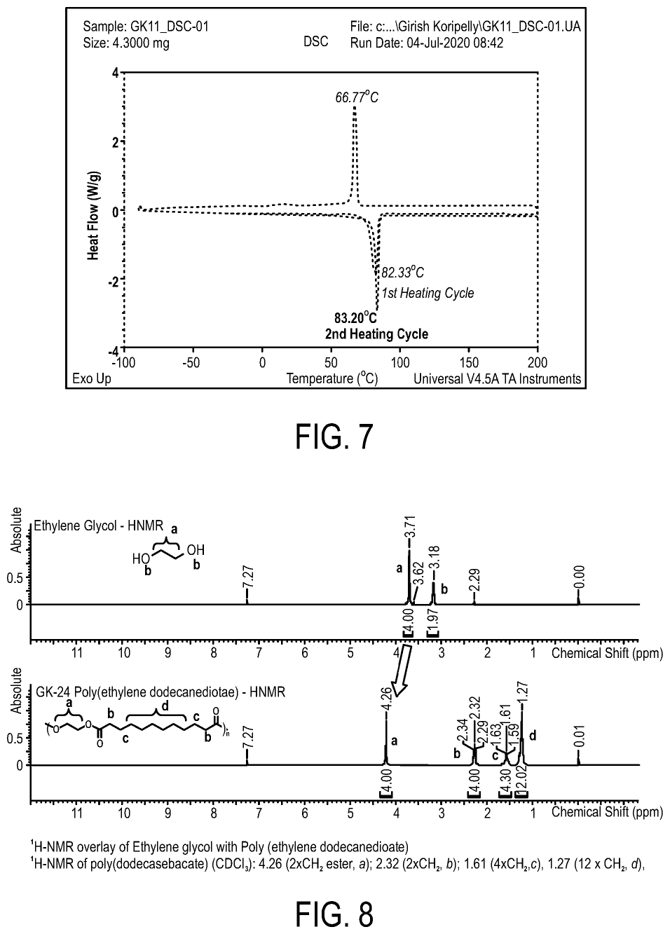

FIG. 7 is a graph of the DSC data of the poly(dodecasebacate), which shows a Tₘ and T_{c} of 83.2° C. and 66.7° C. respectively.

### Results and Discussion

Most commercial diacids, when used as feedstock in esterification and condensation reactions to form polyester-like polymer, do not show polyester like properties because the resultant polymers do not meet an important property—the ester to thousand methylene unit ratio. The ratio for the polymer of Example 3 (a high density polyethylene (HDPE) mimic) was 9.3 (see table below) which is within the range of 0.0001 to 40. Due to this high ratio, the Tₘ is within the range of 40-120° C.

### Comparative Examples—Polyesters

A general synthesis scheme for long chain aliphatic polyesters is described below:

Step 1—esterification: 50.0 mmol α,ω-dihydroxy alkylene, 50.0 mmol α,ω-dicarboxy alkylene and titanium tetra-isopropoxide (1.0 wt % of the polymer) were introduced into the reactor. The reactor was then heated to 190° C. while stirring and in the presence of a nitrogen atmosphere. The esterification conducted for 3.0 hrs at atmospheric pressure.

Step II—polycondensation: After Step I, a polycondensation was initiated by stopping the nitrogen and by gradually reducing the pressure down to approximately 0.05 mbar. The temperature was raised to 220° C., and the reaction was conducted for 4.0 hrs. The vacuum was then released by bleeding in the nitrogen, and the resultant polymer was collected.

The linear diols (1,12-dodecane; 1,8-octane and 1,6-hexane) were purchased from Aldrich. The diacids (sebacic, succinic, tetradecane, dodecane dioic acids) contain 2 to 12 (CH₂) units and were used in the esterification and condensation reaction to form polymeric materials.

A general synthesis scheme for this experiment is shown below:

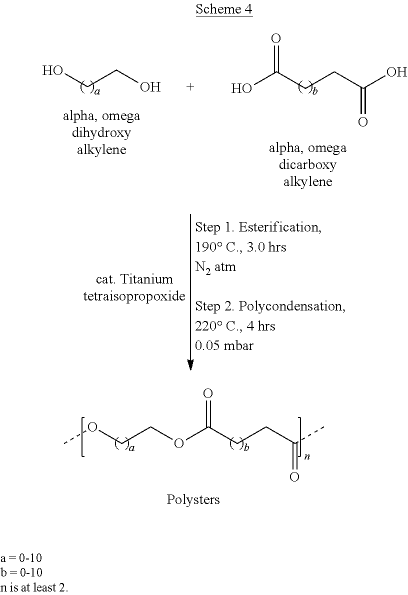

The polymers were characterized by ¹H-NMR, thermal properties by DSC and crystallinity by XRD.

Representative example on synthesis of poly(dodecasebacate) and its analytical characterization.

### Results and Discussion

Most of the commercial diols when used as feedstock in esterification and condensation reaction to form polyethylene-like polymers do not show polyethylene-like properties because they fail to meet an important property, which is the ester to thousand methylene unit ratio. For this example (HDPE mimic) the ratio was 83 to 167 (see table below), which is outside the range of 0.0001 to 40. Due to this high ratio, the Tₘ is very low and polymer are soft hence cannot be true PE-mimics.

Test results show that the polymer had an aliphatic group of 6 and 12 carbon atoms (less than 45), a degree of saturation of 98%, and a melt temperature of 65-70° C. (within the range of (Tₘ) of 40° C. to 180° C.).

The data shows that polymers made in accordance with the present invention are not functionally similar to its conventional counterpart.

### Comparative Example (Reaction of Ethylene Glycol with Dodecanedioic Acid)

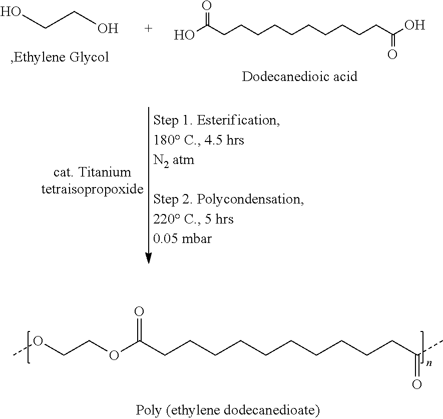

Step I—esterification: 30.0 g (130.2 mmol) dodecanedioic acid, 10.51 g (169.3 mmol) ethylene glycol and 0.48 g titanium tetra-isopropoxide were introduced into the reactor and the reactor was then heated to 180° C. while stirring and under a nitrogen atmosphere. The first stage, esterification was carried out for 4.5 hrs at atmospheric pressure.

Step II—polycondensation: after Step I, a polycondensation reaction started by turning off the nitrogen and by gradually reducing the pressure down to approximately 0.05 mbar. The temperature was raised to 220° C. and the reaction was allowed to take place for 5.0 hrs. The vacuum was released by bleeding in the nitrogen. The resultant polymer, poly(ethylene dodecanedioate) was collected.

The linear diols (1,12 dodecane; 1,8 Octane and 1,6 Hexane) are purchased from Aldrich which has 12 to 6 (CH₂) diacid (sebacic; succinic; tetradecane, dodecane dioic acids) has 2 to 12 (CH₂) which were used in the esterification and condensation reaction to form Polymeric materials.

The poly(ethylene dodecanedioate) was characterized by 1H-NMR as shown in FIG. 8.

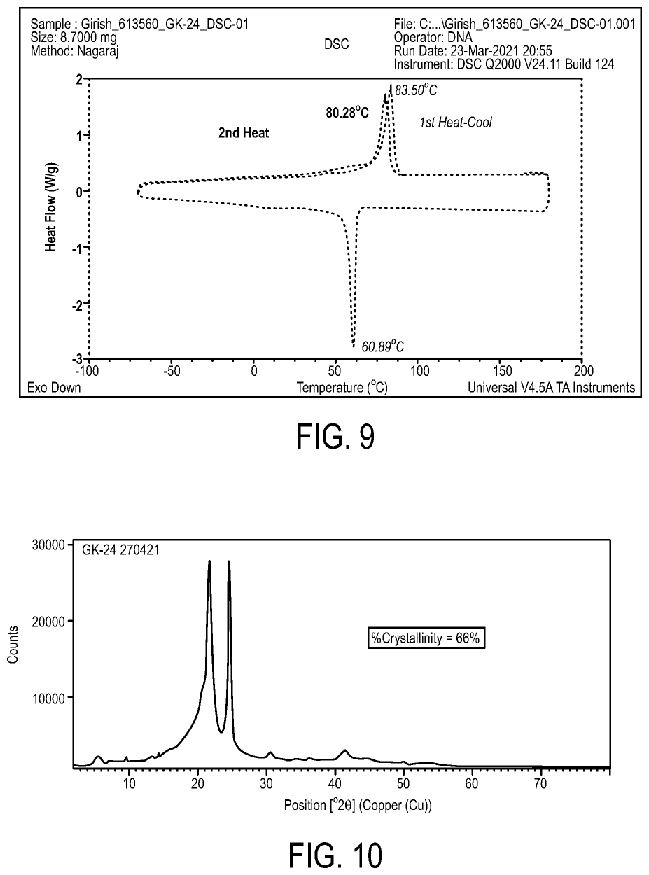

DSC data of the poly(ethylenedodecanedioate) showed a Tₘ and T_{c} of 80.2° C. and 60.8° C. respectively, as shown if FIG. 9.

XRD pattern of Poly (ethylene dodecanedioate) is shown below and the % Crystallinity was found to be 66% as shown in FIG. 10

### Results and Discussion

The results show that the polymer had an aliphatic group of 6 and 12 carbon atoms (less than 45), a degree of saturation of 98%, and a melt temperature of 65-70° C. (within the range of (Tₘ) of 40° C. to 180° C.).

Most of the commercial diols when used as feedstock in esterification and condensation reaction to form polyethylene-like polymer does not show polyethylene-like properties because they do not meet one important property, i.e., the ester to thousand methylene unit ratio. For this example 6 (HDPE mimic) that ratio was 83 to 167 which is outside the range of 0.0001 to 40. Due to this high ratio the Tₘ is very low and polymers are soft, and, therefore, cannot be true polyethylene-mimics.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

What is claimed is:

1. A polymer comprising repeating units of Formula I: 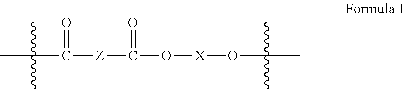
where
X is an aliphatic group, and
Z is an aliphatic group comprising at least 45 carbon atoms, preferably 45 to 1,000 carbon atoms, and has a degree of saturation of 98 to 100%,
wherein the polymer comprises 0.01 to 40 ester groups per 1000 backbone carbon units, and
wherein the polymer has a melt temperature (Tₘ) of 40° C. to 180° C.

2. The polymer of claim 1, wherein Z is a linear or branched hydrocarbon having a degree of branching (DB) of 0 to 10%.

3. The polymer of claim 1, wherein Z is a branched hydrocarbon comprising C₁ to C₁₀ hydrocarbon branches.

4. The polymer of claim 1, wherein Z comprises a polyethylene, poly(ethylene-co-propylene), poly(ethylene-co-1-butene), poly(ethylene-co-1-hexene), or poly(ethylene-co-1-octene) group.

5. The polymer of claim 4, wherein Z comprises a linear or branched polyethylene group.

6. The polymer of claim 1, wherein Z comprises polypropylene group, such as an atactic, isotactic, or syndiotactic polypropylene group.

7. The polymer of claim 1, wherein X comprises 45 to 1,000 carbon atoms, or wherein X is C₁ to C₄₄ aliphatic group, preferably a C₁ to C₂₀ aliphatic group.

8. The polymer of claim 7, wherein X is selected from 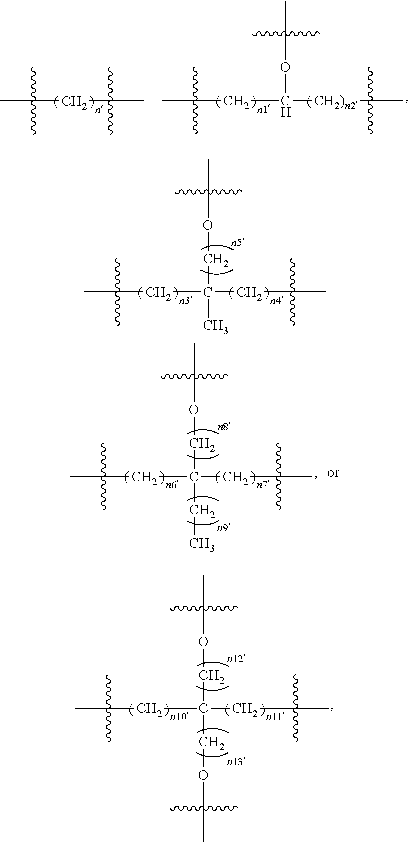
or any combination thereof,
wherein n′ is an integer from 1 to 15, and denotes number of repeat units, and wherein n1′, n2′, n3′, n4′, n5′, n6′, n7′, n8′, n9′, n10′, n11′, n12′, and n13′, are independently an integer from 1 to 5, and denote number of repeat units.

9. The polymer of claim 1, comprising a number average molecular weight of 10,000 to 1,000,000 g/mol, preferably of 20,000 to 500,000 g/mol, more preferably of 40,000 to 200,000 g/mol, said number average molecular weight being determined as the polyethylene equivalent molecular weight by high temperature size exclusion chromatography performed at 160° C. in trichlorobenzene using polyethylene standards.

10. The polymer of claim 1,
i) comprising repeating units of Formula II; or
ii) comprising repeating units of Formula III; or
iii) comprising repeating units of Formula IV,
wherein 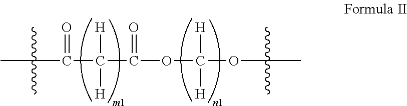
wherein,
n1 is an integer from 1 to 15 and denotes number of repeat units, and
m1 is an integer from 100 to 500 and denotes number of repeat units, 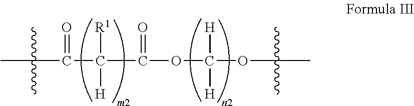
wherein,
n2 is an integer from 0 to 15 and denotes number of repeat units,
m2 is an integer from 100 to 520 and denotes number of repeat units,
R¹ is-H or —CH₂CH₃, and varies independently between H and CH₂CH₃ in the repeating units —CHR¹—, and
—(CHR¹)ₘ₂ group has a DB of 0.1 to 5%. 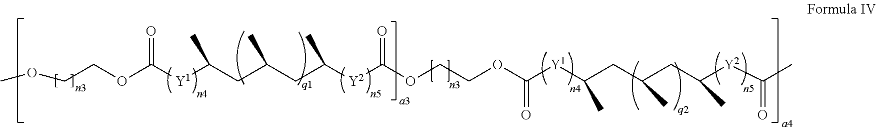
wherein n3 is an integer from 0 to 14 and denotes number of repeat units,
q1 and q2 are independently an integer from 25 to 200 and denote number of repeat units,
n4 and n5 are independently 0 or 1,
Y¹ and Y² are independently a C₁-C₁₀ hydrocarbon, and
a3 and a4 are independently an integer and denotes number of repeat units.

11. The polymer of claim 1, comprising repeating units of a first unit having the formula of Formula I, and repeating units of a second unit having the formula of Formula I, wherein X of the first unit has a different chemical formula than the X of the second unit.

12. A method for forming the polymer of claim 1, the method comprising:
reacting a α,ω-dicarboxylic acid compound having a formula of HO₂C—Z—CO₂H or an ester thereof, with a α,ω-dihydroxy compound having a formula of Formula V, wherein Z is an aliphatic group comprising at least 45 carbon atoms, preferably 45 to 1,000 carbon atoms, and has a degree of saturation of 98 to 100%, wherein Formula V is 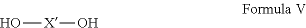
wherein X′ is an aliphatic group, preferably X′ is selected from 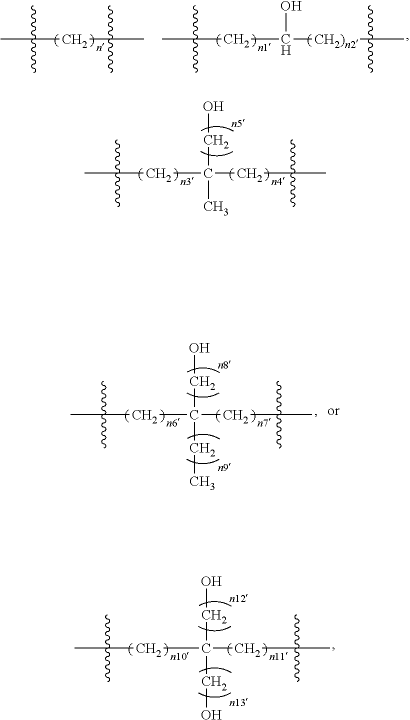
or any combination thereof,
wherein n′ is an integer from 1 to 15, and denotes number of repeat units, and wherein n1′, n2′, n3′, n4′, n5′, n6′, n7′, n8′, n9′, n10′, n11′, n12′, and n13′, are independently an integer from 1 to 5, and denote number of repeat units.

13. The method of claim 12, wherein the α,ω-dihydroxy compound is ethylene glycol, 1,3-propanediol, 1,4-butanediol, 1,6-hexanediol, 1,2-cyclohexanediol, 2-butene-1,4-diol, glycerol, trimethalolmethane, trimethalolethane, trimethalolpropane, 3-hydroxymethyl-1,5-pentanediol, pentaerythritol, or any combinations thereof, and/or wherein the ester is methyl, ethyl and/or propyl ester.

14. The method of claim 12, wherein the α,ω-dihydroxy compound is reacted with the α,ω-dicarboxylic acid compound or ester thereof at i) a temperature of 90 to 250° C., and/or ii) under inert atmosphere and/or vacuum.

15. A method for recycling a polymer of claim 1, the method comprising contacting the polymer with water and/or an alcohol under conditions suitable to depolymerize the polymer through hydrolysis and/or alcoholysis to produce a α,ω-dicarboxylic acid compound having a formula of HO₂C—Z—CO₂H or ester thereof, and an α,ω-dihydroxy compound having a formula of Formula V, wherein Z is an aliphatic group comprising at least 45 carbon atoms, preferably 45 to 1,000 carbon atoms, and has a degree of saturation of 98 to 100%, wherein Formula V is 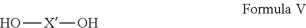
wherein X′ is an aliphatic group.
